(19) United States
(12) Patent Application Publication
(10) Pub. No.: US 2026/0342623 A1
(43) Pub. Date: Oct. 29, 2026

(54) WIRELESS COMMUNICATION METHOD AND RELATED PRODUCTS

(71) Applicant: HUAWEI TECHNOLOGIES CO., LTD., Shenzhen (CN)

(72) Inventors: Sergey Valeryevich SHATILOV, Moscow (RU); Alexander Ivanovich Sherstobitov, Moscow (RU); Evgeny GONCHAROV, Moscow (RU); Vladimir Alexandrovich Lyashev, Moscow (RU); Sergey Petrov, Moscow (RU)

(73) Assignee: HUAWEI TECHNOLOGIES CO., LTD., Shenzhen (CN)

(21) Appl. No.: 19/650,277

(22) Filed: Apr. 16, 2026

Related U.S. Application Data
(63) Continuation of application No. PCT/RU2023/000345, filed on Nov. 14, 2023.

(51) Int. Cl. H04L 25/02; H04B 7/0417; H04B 7/06

(52) U.S. Cl. CPC H04L 25/0242; H04B 7/0417; H04B 7/0626; H04L 25/0228

(57) ABSTRACT

The present disclosure provides a wireless communication method and related products. The wireless communication method includes: obtaining channel state information (CSI); determining a first estimation of the CSI, where the first estimation is for representing a canonical decomposition of the CSI and includes a preset number of factor vectors, where at least one factor vector of the preset number of factor vectors is subject to sub-dimensional splitting; and generating, a CSI report based on the first estimation of the CSI.

### CROSS-REFERENCE TO RELATED APPLICATIONS

This application is a continuation of International Application No. PCT/RU2023/000345, filed on Nov. 14, 2023, the disclosure of which is hereby incorporated by reference in its entirety.

### TECHNICAL FIELD

The present disclosure relates to the field of data transmission, and particularly to a wireless communication method and related products.

### BACKGROUND

The rapid growth of modern telecommunications and global network evolution at the appropriate pace for the market need and the local state of readiness requires a significant increase in the rate of data transmission, coverage and capacity of communication systems. To achieve these goals, one possible technique is to increase the number of transmit and receive antennas.

One of the key challenges for Multiple Input Multiple Output (MIMO) systems is the ability to know channel state information (CSI) with high accuracy at the evolved Node B (eNodeB or eNB). It is needed to exploit the best capacity of such technology. For a time division duplexing (TDD) system, the problem may be solved by reciprocity between the downlink (DL) and uplink (UL) channels. For a frequency division duplexing (FDD) system, for the sake of efficiency, eNodeB needs to acquire DL channel conditions from user equipment (UE). For this purpose, reference symbols are transmitted by eNodeB, on which UE could perform measurements so as to obtain a state of the DL channel, and thus reports such state to the eNodeB.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, the present disclosure provides a wireless communication method, where the method includes:
obtaining, by a receiver, CSI;
determining, by the receiver, a first estimation of the CSI, where the first estimation is for representing a canonical decomposition of the CSI and includes a preset number of factor vectors, where at least one factor vector of the preset number of factor vectors is subject to sub-dimensional splitting; and
generating, by the receiver, a CSI report based on the first estimation of the CSI.

By using the first estimation for representing the canonical decomposition of the CSI and making at least one factor vector of the preset number of factor vectors included in the first estimation being subject to sub-dimensional splitting, the parameters required for channel representation with high accuracy can be significantly reduced, thereby realizing CSI reporting with less feedback overhead.

In a possible implementation of the first aspect, the determining, by the receiver, the first estimation of the CSI includes:
determining, by the receiver, a sub-dimensional representation for each of the at least one factor vector; and
obtaining, by the receiver, the first estimation of the CSI based on the sub-dimensional representation for each of the at least one factor vector.

In order to achieve the sub-dimensional splitting of the at least one factor vector, the sub-dimensional representation for each of the at least one factor vector is determined and the first estimation of the CSI is thus obtained based on such sub-dimensional representation, which makes it easier to obtain the first estimation of the CSI, thus simplifying the operations, reducing the amount of parameters for representing the CSI, and further increasing the efficiency of the channel estimation.

In a possible implementation of the first aspect, the determining, by the receiver, the sub-dimensional representation for each of the at least one factor vector includes:
determining, by the receiver, at least one sub-dimensional parameter size for each of the at least one factor vector based on a first preset configuration corresponding to the CSI; and
representing, by the receiver, for each of the at least one factor vector with the at least one sub-dimensional parameter size for each of the at least one factor vector.

In a possible implementation of the first aspect, for each of the at least one factor vector: the at least one sub-dimensional parameter size includes a first sub-dimensional parameter size and a second sub-dimensional parameter size, where the first sub-dimensional parameter size includes at least one factor indicating a size of a sub-dimension, and the second sub-dimensional parameter size represents a number of sub-dimensions for representing the factor vector; where the sub-dimensional representation for the factor vector is a Kronecker product of sub-split elements, where each of the sub-split elements is represented in an exponential form based on a phase corresponding to the factor vector, the first sub-dimensional parameter size of the factor vector and the second sub-dimensional parameter size of the factor vector.

In a possible implementation of the first aspect, the first preset configuration is indicative of a number of sub-dimensions for the sub-dimensional splitting of each of the at least one factor vector and a size of a respective sub-dimension of the sub-dimensions.

In a possible implementation of the first aspect, the obtaining, by the receiver, the first estimation of the CSI based on the sub-dimensional representation for each of the at least one factor vector includes:
obtaining, by the receiver, the first estimation of the CSI by using the sub-dimensional representation for each of the at least one factor vector as input of a first preset algorithm.

In a possible implementation of the first aspect, the generating, by the receiver, the CSI report based on the first estimation of the CSI includes:
generating, by the receiver, the CSI report based on a second preset configuration and the first estimation of the CSI, where the second preset configuration is indicative of whether a preset structure is applied for a first factor vector of the preset number of factor vectors.

In a possible implementation of the first aspect, the second preset configuration is indicative of applying the preset structure for the first factor vector of the preset number of factor vectors;
the generating, by the receiver, the CSI report includes:
performing, by the receiver, factor approximation on the first estimation based on a second preset algorithm to derive a characterization parameter of the first factor vector; and
generating, by the receiver, the CSI report based on the characterization parameter of the first factor vector.

By assuming a preset structure for the first factor vector(s) among the preset number of factor vectors, factor approximation could be enabled for the first factor vector(s), thereby making it possible to represent the first factor vector(s) with fewer parameters, thereby reducing feedback overhead.

In a possible implementation of the first aspect, the second preset configuration is indicative of not applying the preset structure for the first factor vector of the preset number of factor vectors; the generating, by the receiver, the CSI report includes:
generating, by the receiver, the CSI report based on the first estimation.

In a possible implementation of the first aspect, the preset structure is a parametric structure.

In a possible implementation of the first aspect, the parametric structure includes at least one of a steering structure, a quadratic structure or a cubic structure.

Flexibility is achieved by introducing various kinds of parametric structures.

In a possible implementation of the first aspect, the method further includes:
receiving, by the receiver, first information indicative of the second preset configuration from a wireless communication system.

In a possible implementation of the first aspect, the generating, by the receiver, the CSI report further includes:
performing, by the receiver, an extrapolation operation on the first estimation to obtain an extrapolated first estimation for a next time unit; and
generating, by the receiver, the CSI report based on the extrapolated first estimation of the CSI.

In a possible implementation of the first aspect, before obtaining, by the receiver, the first estimation of the CSI by using the sub-dimensional representation for each of the at least one factor vector as input of a first preset algorithm, the method further includes:
obtaining, by the receiver, an initial sub-dimensional representation of each of the at least one factor vector based on the CSI;
the obtaining, by the receiver, the first estimation of the CSI by using the sub-dimensional representation for each of the at least one factor vector as input of the first preset algorithm includes:
obtaining, by the receiver, the first estimation of the CSI by using the initial sub-dimensional representation as the input of the first preset algorithm.

In a possible implementation of the first aspect, the obtaining, by the receiver, the initial sub-dimensional representation for each of the at least one factor vector based on the CSI includes:
obtaining, by the receiver, the initial sub-dimensional representation for each of the at least one factor vector and a rank for the canonical decomposition of the CSI based on a discrete Fourier transform (DFT) operation of the CSI;
the obtaining, by the receiver, the first estimation of the CSI by using the sub-dimensional representation for each of the at least one factor vector as input of the first preset algorithm includes:
obtaining, by the receiver, the first estimation of the CSI by using the initial sub-dimensional representation and the rank for the canonical decomposition as the input of the first preset algorithm.

In a possible implementation of the first aspect, the obtaining, by the receiver, the initial sub-dimensional representation for each of the at least one factor vector and the rank for the canonical decomposition of the CSI based on the DFT operation of the CSI includes:
determining, by the receiver, an extended channel matrix based on the CSI and a preset oversampling parameter;
performing, by the receiver, a Discrete Fourier Transform DFT operation on the extended channel matrix to obtain a power spectrum of the CSI; and
determining, by the receiver, the initial sub-dimensional representation for each of the at least one factor vector and the rank for the canonical decomposition of the CSI based on the power spectrum of the CSI.

In a possible implementation of the first aspect, the obtaining, by the receiver, the initial sub-dimensional representation for each of the at least one factor vector based on the CSI includes:
using, by the receiver, an extrapolated first estimation as the initial sub-dimensional representation for each of the at least one factor vector, where the extrapolated first estimation is obtained by performing an extrapolation operation on a first estimation determined in a previous time unit.

By introducing extrapolation in the process of channel estimation, the extrapolated first estimation may have better robustness in terms of the problem of “channel aging”.

In a possible implementation of the first aspect, the CSI includes first channel information about a time domain, second channel information about a frequency domain and third channel information about a spatial domain; the preset number of factor vectors includes a time factor vector for characterizing the first channel information, a subcarrier factor vector for characterizing the second channel information, and a transmitting factor vector and a receiving factor vector for characterizing the third channel information; at least one of the time factor vector, the subcarrier factor vector, the transmitting factor vector, and the receiving factor vector is represented with regularly changed phases.

In a possible implementation of the first aspect, the transmitting factor vector includes a first transmitting factor vector and a second transmitting factor vector, the first transmitting factor vector is used for characterizing channel information of at least one vertical polarized antenna port, and the second transmitting factor vector is used for characterizing channel information of at least one horizontal polarized antenna port.

By splitting the transmitting factor vector further into two sub-dimensions, the polarization of the transmitting antenna is taken into account, the applicability of the solution is thus improved.

In a possible implementation of the first aspect, the method further includes:
transmitting, by the receiver, the CSI report to a wireless communication system.

In a possible implementation of the first aspect, the method further includes:
receiving, by the receiver, second information indicative of the preset number from a wireless communication system.

In a second aspect, the present disclosure provides a wireless communication method, where the method includes:
receiving, by a transmitter, a CSI report from a receiver, where the CSI report is generated by the receiver based on a first estimation of CSI, where the first estimation is for representing a canonical decomposition of the CSI and includes a preset number of factor vectors, and at least one factor vector of the preset number of factor vectors is subject to sub-dimensional splitting; and
determining, by the transmitter, the CSI based on the CSI report.

Because the CSI report is generated based on a first estimation of the CSI which is used for representing a canonical decomposition of the CSI and includes a preset number of factor vectors, where at least one factor vector of the preset number of factor vectors is subject to sub-dimensional splitting, the parameters required for channel representation with high accuracy can be significantly reduced, thereby realizing CSI reporting with less feedback overhead.

In a possible implementation of the second aspect, the method further includes:
transmitting, by the transmitter, first information indicative of second preset configuration to the receiver, where the second preset configuration is indicative of whether a preset structure is applied for a first factor vector of the preset number of factor vectors.

In a possible implementation of the second aspect, the method further includes:
transmitting, by the transmitter, second information indicative of the preset number to the receiver.

In a third aspect, the present disclosure provides a wireless communication apparatus, where the apparatus includes: an obtaining module, configured to obtain CSI; a determining module, configured to determine a first estimation of the CSI, where the first estimation is for representing a canonical decomposition of the CSI and includes a preset number of factor vectors, where at least one factor vector of the preset number of factor vectors is subject to sub-dimensional splitting; and, a generating module, configured to generate a CSI report based on the first estimation of the CSI.

In a fourth aspect, the present disclosure provides a wireless communication apparatus, where the apparatus includes: a receiving module, configured to receive a CSI report from a receiver, where the CSI report is generated by the receiver based on a first estimation of CSI, where the first estimation is for representing a canonical decomposition of the CSI and includes a preset number of factor vectors, and at least one factor vector of the preset number of factor vectors is subject to sub-dimensional splitting; and, a determining module, configured to determine the CSI based on the CSI report.

In a fifth aspect, the present disclosure provides a terminal device including a processing circuitry for executing the wireless communication method according to the first aspect or any implementation of the first aspect.

In a sixth aspect, the present disclosure provides a network device including a processing circuitry for executing the wireless communication method according to the second aspect or any implementation of the second aspect.

In a seventh aspect, the present disclosure provides a wireless communication system including a terminal device according to the fifth aspect and a network device according to the sixth aspect.

In an eighth aspect, the present disclosure provides a chip, including an input/output (I/O) interface and a processor, where the processor is configured to call and run computer execution instructions stored in a memory, to enable a device installing with the chip to execute the wireless communication method according to the first aspect or any implementation of the first aspect or the second aspect or any implementation of the second aspect.

In a ninth aspect, the present disclosure provides a computer-readable storage medium storing computer execution instructions which, when executed by a processor, cause the processor to execute the wireless communication method according to the first aspect or any implementation of the first aspect or the second aspect or any implementation of the second aspect.

In a tenth aspect, the present disclosure provides a computer program product including computer execution instructions which, when executed by a processor, causes the processor to execute the wireless communication method according to the first aspect or any implementation of the first aspect or the second aspect or any implementation of the second aspect.

The present disclosure provides a wireless communication method and related products. The wireless communication method includes: obtaining, by a receiver, CSI; determining, by the receiver, a first estimation of the CSI, where the first estimation is for representing a canonical decomposition of the CSI and includes a preset number of factor vectors, where at least one factor vector of the preset number of factor vectors is subject to sub-dimensional splitting; and generating, by the receiver, a CSI report based on the first estimation of the CSI. By using the first estimation for representing the canonical decomposition of the CSI and making at least one factor vector of the preset number of factor vectors included in the first estimation being subject to sub-dimensional splitting, the parameters required for channel representation with high accuracy can be significantly reduced, thereby realizing CSI reporting with less feedback overhead.

### BRIEF DESCRIPTION OF DRAWINGS

Reference will now be made, by way of example, to the accompanying drawings which show example embodiments of the present disclosure.

FIG. 1 is a schematic illustration of a communication system according to one or more example embodiments of the present disclosure.

FIG. 2 is another schematic illustration of a communication system according to one or more example embodiments of the present disclosure.

FIG. 3 is a schematic illustration of basic component structure of a communication system according to one or more example embodiments of the present disclosure.

FIG. 4 illustrates a block diagram of a device in a communication system according to one or more example embodiments of the present disclosure.

FIG. 5 is a schematic flowchart of a wireless communication method according to one or more example embodiments of the present disclosure.

FIG. 6 is an example of a tensor according to one or more example embodiments of the present disclosure.

FIG. 7A and FIG. 7B show dimensions splitting of a channel tensor according to one or more example embodiments of the present disclosure.

FIG. 8 is an illustration of selection of peak for case R=6 according to one or more example embodiments of the present disclosure.

FIG. 9 is an illustration of approximation of TX1 factors for rank R=8 according to one or more example embodiments of the present disclosure.

FIG. 10 shows output of ALS—rough factors, TTI dimension, 16 samples in time/TTI, ranks 8, UE1.

FIG. 11 shows output of ALS-rough factors, TTI dimension, 16 samples in time/TTI, rank 8, UE2.

FIG. 12 is a flowchart of extrapolation of factors according to one or more example embodiments of the present disclosure.

FIG. 13 is an example with 32 transmitting antennas according to one or more example embodiments of the present disclosure.

FIG. 14 is a result of simulation for single-layer transmission according to one or more example embodiments of the present disclosure.

FIG. 15 is another result of simulation for single-layer transmission according to one or more example embodiments of the present disclosure.

FIG. 16 is a result of simulation for two-layer transmission according to one or more example embodiments of the present disclosure.

FIG. 17 is a result of simulation for three-layer transmission according to one or more example embodiments of the present disclosure.

FIG. 18 is a result of simulation for four-layer transmission according to one or more example embodiments of the present disclosure

FIG. 19 is another schematic flowchart of a wireless communication method according to one or more example embodiments of the present disclosure.

FIG. 20 is a schematic structural diagram of a wireless communication apparatus according to one or more example embodiments of the present disclosure.

FIG. 21 is a schematic structural diagram of a wireless communication apparatus according to one or more example embodiments of the present disclosure.

### DESCRIPTION OF EMBODIMENTS

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

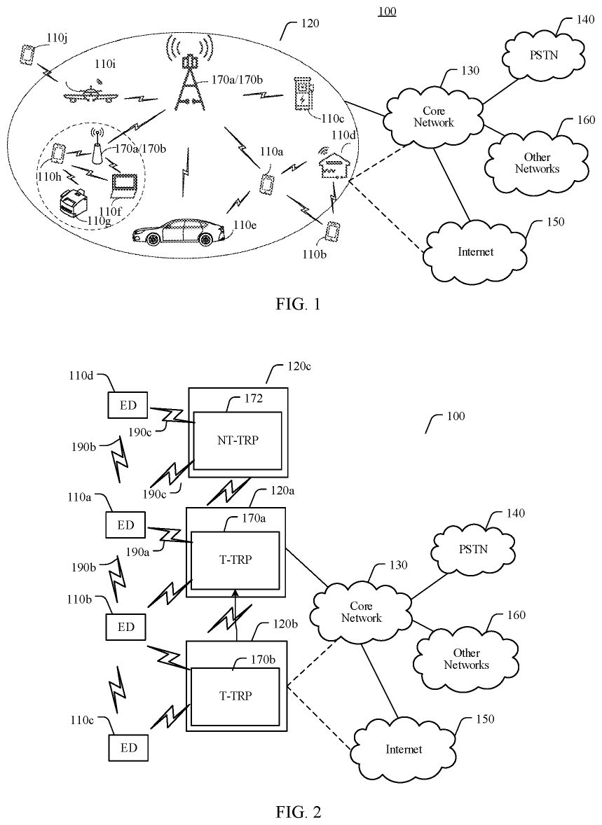

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., 5G, 4G, 3G or 2G) radio access network. One or more communication electric devices (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

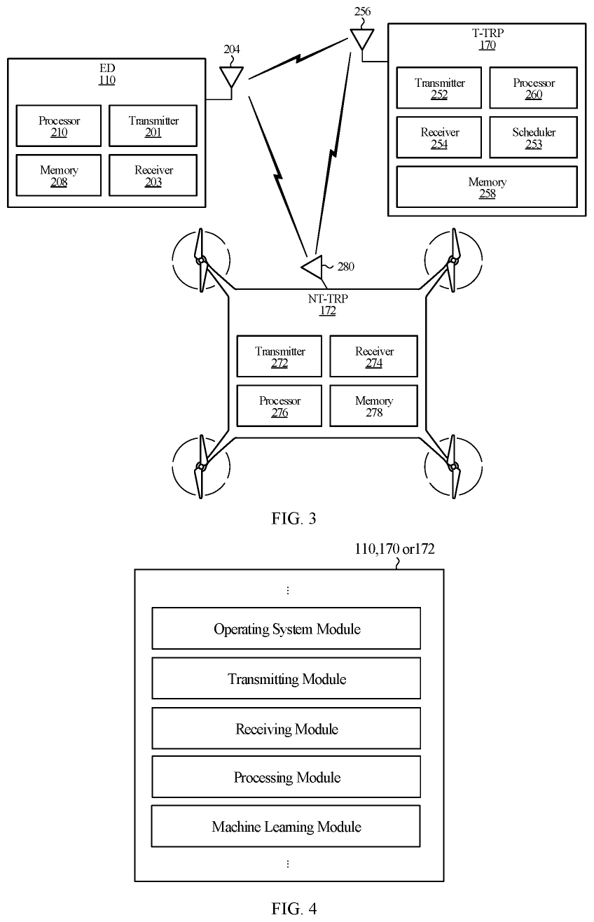

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms.

The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission.

Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

In some implementations, the ED 110 may be an apparatus (also called component) for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

The T-TRP 170 may be known by other names in some implementations, such as a base station, a base transceiver station (BTS), a radio base station, a network node, a network device, a device on the network side, a transmit/receive node, a Node B, an eNB, a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

When the T-TRP 170 is an apparatus (also called as component), for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data.

Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 272 and receiver 257 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “TRP”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”).

The T-TRP 170, the NT-TRP 172, and/or the ED 110 may include other components, but these have been omitted for the sake of clarity.

### Basic Module Structure

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### DEFINITIONS OF ACRONYMS & GLOSSARIES

3GPP—3rd Generation Partnership project
NR—New Radio
BS—Base Station
CSI—Channel State Information
DFT—Discrete Fourier Transform
DL—Downlink
eNodeB—Base Station system in 3GPP terminology
TDD—Time Division Duplexing
FDD—Frequency Division Duplexing
FFT—Fast Fourier Transform
SU—Single-User
MU—Multi-User
MIMO—Multiple Input/Multiple Output
UE—User Equipment
UL—Uplink
Uma—Urban Macro

As an application to the massive MIMO topic, canonical decomposition can be used. However, in existing approaches, some may use a predefined number of orthogonal components in spatial, frequency and Doppler domains (these orthogonal components are determined and reported from a terminal to a base station), which leads to loss of performance in comparison with joint non-orthogonal basis across spatial-frequency-Doppler domains.

The amount of the CSI report is tradeoff between accuracy of a DL channel representation and overhead (system resources and air signaling used for the CSI report in UL). There are some approaches of a CSI compression in NR standard such as Type I and Type II codebooks. Type I codebook is designed for SU mode transmission and Type II codebook is designed for MU mode. Type II codebook has higher accuracy than type I codebook, but has some drawbacks such as low accuracy of the higher channel ranks representation and higher performance degradation in time due to aperiodic nature of such report and delay between DL and UL messages (round trip delay), which leads to some usage delay of obtained CSI. These drawbacks of existing standard codebook necessitates design of more efficient channel compression algorithm, which can achieve desirable performance for ranks up to 4 and comparable overhead with existed standard Type II codebook.

When facing increased high ranks of channels (up to 4), the accuracy of channel representation/compression may become relatively low. There are many terminals which have at least 4 receive antennas. Based on system level simulations and real field tests, 2-4 ranks are most reported from UE to the eNodeB. Existing solutions have poor accuracy of high ranks representation/compression.

In the following, the present disclosure presents a proposal to tackle this issue. The purpose of the present disclosure is to provide channel state information compression in order to reduce feedback overhead in a diversity of scenarios with similar issues. The present disclosure is based on increasing demission of original channel tensor (using virtual additional dimensions), tensor decomposition, and approximation of particular factors (factor vectors) by steering vector and extrapolation time factors. The idea is applicable to any scenario where channel state information may need to be transmitted with the constraint of limited feedback. Some examples where the present disclosure can be exploited would be: FDD MIMO feedback mechanism, cloud RAN with limited backhaul, channel feedback for millimeter wave scenarios, cooperative multi-point MIMO feedback mechanism.

The idea of the present disclosure consists in taking the concept of canonical decomposition to reduce the spatial-frequency-time information of the channel to be reported. Canonical decomposition is used instead of other types of decompositions (Tucker decomposition, Tensor train, etc.) due to both the less complexity for sufficient quality of MIMO channel representation and less required parameters to represent CSI.

Further based on the canonical decomposition, it is proposed in the present disclosure to use virtual dimensions (or referred as sub-dimensions), which can provide opportunities to represent MIMO channel with high desirable accuracy and lowest number of parameters. Each such virtual dimension of tensor (or referred to as factor vector) may contain smallest possible size (e.g., 2 element per dimension). Approximation of the channel in each dimension is carried out by vectors having a so called “steering” structure. Decomposition of channel virtual dimensions/factors may be calculated by alternating least squares (ALS) algorithm, which would give as result vectors with non-orthogonal nature. To provide robust performance to CSI degradation (so as to resist channel aging) in time an extrapolation of factors, having a parametric structure, e.g., a “steering” structure (which will be described later in details) over the time, are made to obtain prediction of the channel in the future.

Further, the provided solution of propagation channel compression demonstrates good performance at different propagation channel scenarios like urban, rural, suburban types of the channel, signal to interference plus noise ratio (SINR), as well as for different UE speeds, like 3-10 km/h, and more.

The disclosure also provides an embodiment in which approximation of the channel is used in dimensions by vectors having a parametric structure, not only “steering” structure, but could also be other structures, quadratic, cubic, and so on. Also switch on/off dimensions or part of dimensions from channel representation can be made, as well as the parameters of algorithm can be adjusted to correspond to the current propagation channel conditions.

Discrete Fourier transform (DFT) as initial approximation of the channel for first ALS iterations may be made to reduce complexity of algorithm and decrease number of required iterations of ALS. Approximation can be made by other methods, not only ALS—for example,

Levenberg-Marquardt algorithm, etc.

The present disclosure proposes a wireless communication method and/or device of MIMO channel representation (approximation) by piecewise linear non-orthogonal vectors whichever across full dimensions of spatial, frequency and time domains or sub-dimensions of spatial, frequency and time domains. Proposed approach can significantly reduce overhead when transmitting CSI from UE to eNodeB, obtain good quality prediction channel in various propagation channel conditions, SNRs, various number and configuration of transmit and receive antennas, bandwidth of the signal.

Proposed solution possesses an ability to accomplish rank adaptation in MU mode at the eNodeB. Considered disclosure compresses channel itself (channel-based approach), which it gives opportunities to extract eigenvalues and use them for rank selection adaptation at the eNodeB.

Proposed solution has robust performances to the UE mobility or to aperiodic nature of CSI report with high accuracy. CSI report with high accuracy is aperiodic in general due to limitation of resources in UL. To keep stable performance during some time interval is desired property of CSI. Considered disclosure can provide robust performance to aperiodic nature of CSI or UE mobility.

The principle of the present disclosure consists of using canonical decomposition to represent MIMO channel in spatial-frequency-time domain. Additional splitting of TX antenna by double dimension is obtained for realization of two-dimensional antenna arrays.

The details of the present disclosure will be elaborated in the following description.

FIG. 5 is a schematic flowchart of a wireless communication method according to one or more example embodiments of the present disclosure. The method can be implemented by a receiver. Optionally, the receiver may be a terminal device or other device that has similar function (for example, the receiver could be a chip), which is not limited herein. As shown in FIG. 5, the method may include the following steps.

S510, a receiver obtains CSI.

Here the CSI is actual channel state information between a transmitter and the receiver. The CSI may also be referred to as, e.g., exact CSI that is measured by the receiver. The measurement may be made based on a signal sent from the transmitter to the receiver. Techniques in existing art may be adopted here for obtaining the CSI, which will not be elaborated here for brevity.

S520, the receiver determines a first estimation of the CSI, where the first estimation is for representing a canonical decomposition of the CSI and includes a preset number of factor vectors, wherein at least one factor vector of the preset number of factor vectors is subject to sub-dimensional splitting.

After obtaining the CSI, as described above, due to constrained feedback resources, the CSI may have to be subject to some processing, so as to obtain an estimation thereof suitable for generating the CSI report. It is thus proposed to introduce the canonical decomposition in estimating the CSI, and further, on the basis of the canonical decomposition of the CSI, it is also proposed to perform sub-dimensional splitting on the tensors used in the canonical decomposition.

Here the sub-dimensional splitting may also be called virtual dimension splitting. The principle is to divide a size of a factor vector into smallest possible sizes, so as to represent the factor vector with sub-split elements in sub-dimensions (virtual dimensions), the size of the factor vector before the sub-dimensional splitting may be greater than the size of each sub-dimensions of the factor vector after the sub-dimensional splitting.

By using the sub-dimensional splitting, the smallest possible sizes may be introduced for representing the factor vector, such splitting may contribute to the reduction of parameters used for representing the factor vector. Normally, the size of the factor vector may be split in a way that the sizes of the sub-dimensions are the smallest possible integers.

It should be noted that the at least one factor vector here could be one of the preset number of factor vectors, or all of the preset number of factor vectors, or could also be some of them, which is not limited by the embodiments of the present disclosure. When multiple factor vectors among the preset number of factor vectors are subject to sub-dimensional splitting, the sub-dimensions involved with such splitting for the respective factor vectors may be the same, or different, which is not limited by the embodiments of the present disclosure.

Besides, the preset number here represents the number of factor vectors used in the canonical decomposition, and can be a value predefined prior to the estimation of the CSI. This value can be a fixed value known by both of the receiver and the transmitter, or can also be a value notified by the transmitter. This predefined value could be dependent on the information amount of the CSI to be estimated. For example, the CSI includes information in three domains, i.e., the time domain, the frequency domain and the spatial domain, then as an implementation, the preset number is set to be four, that means four factor vectors could be used for developing the canonical decomposition of the CSI, one factor vector may be taken for characterizing information in the time domain, one factor vector may be taken for characterizing information in the frequency domain, and two factor vectors may be taken for characterizing information in the spatial domain. In the following, examples may be given by taking the preset number as five (one factor vector for characterizing the state of the channel in the time domain, one factor vector for characterizing the state of the channel in the frequency domain, and three factor vectors for characterizing the state of the channel in the spatial domain—two for transmitting antenna and one for receiving antenna), however, it should be noted that more or less factor vectors may be used, depending on the aforementioned information amount contained in the CSI, or other factors, e.g., specific algorithm used for realizing the canonical decomposition.

As described above, the at least one factor vector may undergo sub-dimensional splitting or in other words virtual dimension splitting. In an implementation, such splitting may be implemented as follows: the receiver may determine a sub-dimensional representation for each of the at least one factor vector, and then obtain the first estimation of the CSI based on the sub-dimensional representation for each of the at least one factor vector. In order to achieve the sub-dimensional splitting of the at least one factor vector, the sub-dimensional representation for each of the at least one factor vector is determined and the first estimation of the CSI is thus obtained based on such sub-dimensional representation, which makes it easier to obtain the first estimation of the CSI, thus simplifying the operations, reducing the amount of parameters for representing the CSI, and further increasing the efficiency of the channel estimation.

Each factor vector may have its corresponding sub-dimensional representation, and if all of the preset number of factor vectors are subject to sub-dimensional splitting, then the obtaining of the first estimation of the CSI may be based on the sub-dimensional representations for all of the preset number of factor vectors; if some of the preset number of factor vectors are subject to sub-dimensional splitting while the remaining factor vector(s) are not subject to sub-dimensional splitting, then the obtaining of the first estimation of the CSI may be based on the sub-dimensional representations for some of the preset number of factor vectors.

For the determination of the sub-dimensional representation for each of the at least one factor vector, in a possible implementation, the receiver may determine at least one sub-dimensional parameter size for each of the at least one factor vector based on a first preset configuration corresponding to the CSI, and represent for each of the at least one factor vector with the at least one sub-dimensional parameter size, here the first preset configuration may be indicative of the number of sub-dimensions for the sub-dimensional splitting of each of the at least one factor vector and a size of a respective sub-dimension of the sub-dimensions. Then the receiver may obtain the first estimation of the CSI by using the sub-dimensional representation for each of the at least one factor vector as input of a first preset algorithm. For example, the first preset configuration may be the number of transmitting antennas, and based on such number, the number of sub-dimensions for the sub-dimensional splitting of the factor vector (which is used for representing channel information characterizing the transmitting antennas) may be determined.

For each of the at least one factor vector, the at least one sub-dimensional parameter size includes a first sub-dimensional parameter size and a second sub-dimensional parameter size, where the first sub-dimensional parameter size includes at least one factor indicating a size of a sub-dimension, and the second sub-dimensional parameter size represents a number of sub-dimensions for representing the factor vector. The sub-dimensional representation for the factor vector is a Kronecker product of sub-split elements, where each of the sub-split elements is represented in an exponential form based on a phase corresponding to the factor vector, the first sub-dimensional parameter size of the factor vector and the second sub-dimensional parameter size of the factor vector.

After determining the sub-dimensional representation for each of the at least one factor vector, the receiver may obtain the first estimation of the CSI based on the sub-dimensional representation for each of the at least one factor vector. In a possible implementation, the receiver may obtain the first estimation of the CSI by using the sub-dimensional representation for each of the at least one factor vector as input of a first preset algorithm. That is, the first preset algorithm may be used for determining the preset number of factor vectors included in the first estimation, with at least one of these factor vectors being represented in the form of sub-dimensional representation, here the first preset algorithm may be any algorithm that could be used for calculating the factor vectors of the canonical decomposition of the CSI, for example, it could be the ALS algorithm. Other algorithms may also be adopted, for example, Levenberg-Marquardt algorithm, etc. It should be noted that if not all of the preset number of factor vectors are subject to sub-dimensional splitting, then the input of the first preset algorithm may be the sub-dimensional representation for each of the factor vectors subject to sub-dimensional splitting.

For ease of understanding, a specific example is introduced to explain the related terms more clearly. It should be noted that the number of the factor vectors before the sub-dimensional splitting (the preset number), the number of factor vectors subject to the sub-dimensional splitting (those called “at least one factor vector in the above description”), as well as the number and sizes of sub-dimensions for each factor vector subject to the sub-dimensional splitting in the example are just for illustration purpose, rather than limitation.

We assume that the CSI may contain channel information in the time domain which is represented by tensor V^{tti} with a size of N^{tti}, channel information in the frequency domain which is represented by tensor V^{sc} with a size of N^{sc}, and channel information related to the transmitting antennas which is represented by tensor V^{tx} (including V^{tx1} and V^{tx2} with a size of N^{tx1} and N^{tx2} respectively, channel information related to the receiving antennas which is represented by tensor V^{rx} with a size of Nᵣₓ. Here the terms channel tensor, tensor and factor vector are used interchangeably throughout the text.

The propagation channel (the aforementioned practical CSI) may be presented in the following form by using canonical decomposition:

$$H ( tx 1 , tx 2 , rx , sc , tti ) = {\sum }_{r = 1}^{R} {V}^{tx 1} ( tx 1 , r ) \cdot {V}^{tx 2} ( tx 2 , r ) \cdot {V}^{rx} ( rx , r ) \cdot {V}^{sc} ( sc , r ) \cdot {V}^{tti} ( tti , r ) \qquad ( 1 )$$

where tx1=1 . . . . Nₜₓ₁, tx2=1 . . . . Nₜₓ₂, rx=1 . . . . Nᵣₓ, sc=1 . . . . N_{sc}, tti=1 . . . . Nₜₜᵢ, R-rank (rank refers to the rank of the canonical decomposition)

Here we use V^{tx1} and V^{tx2} to characterize the channel information for both polarizations (vertical and horizontal) of the transmitting antennas, it should be noted that we may also use just one tensor for representing the channel information related to the transmitting antennas, which is not limited in the embodiments of the present disclosure.

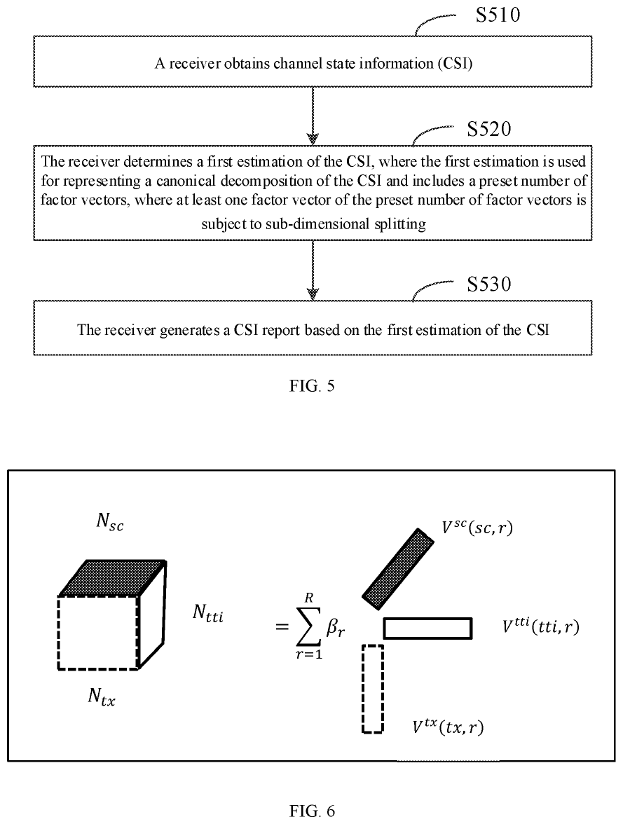

As shown in FIG. 6, which is an example of a tensor according to one or more example embodiments of the present disclosure. Here simply the three tenors V^{sc}, V^{tti}, and V^{tx} are shown, for each receiving antenna, we may have such decomposition.

In this example, approximation of the channel in each dimension is carried out by vectors having a so called “steering” structure, where:

$${V}^{tx 1} = [ \begin{matrix}1 & {e}^{j {φ}_{r}^{tx 1}} & {e}^{j 2 {φ}_{r}^{tx 1}} & …\end{matrix} ]$$

$${V}^{tx 2} = [ \begin{matrix}1 & {e}^{j {φ}_{r}^{tx 2}} & {e}^{j 2 {φ}_{r}^{tx 2}} & …\end{matrix} ]$$

$${V}^{rx} = [ \begin{matrix}1 & {e}^{j {φ}_{r}^{rx}} & {e}^{j 2 {φ}_{r}^{rx}} & …\end{matrix} ]$$

$${V}^{sc} = [ \begin{matrix}1 & {e}^{j {φ}_{r}^{sc}} & {e}^{j 2 {φ}_{r}^{sc}} & …\end{matrix} ]$$

$${V}^{tti} = [ \begin{matrix}1 & {α}_{r} {e}^{j {φ}_{r}^{tti}} & {α}_{r}^{2} {e}^{j 2 {φ}_{r}^{tti}} & …\end{matrix} ]$$

Sub-dimensional splitting (partitioning) of each tensor into the smallest possible sizes is made to increase the performance of total channel representation (dimensions splitting). If we perform sub-dimensional splitting on all of the five tensors, then the sub-dimensional representation of each of the five tensors would be:

$${V}^{tx 1} ( tx 1 , r ) = {Q}^{tx 1 , 1} ( tx 1 , r ) ⊗ {Q}^{tx 1 , 2} ( tx 1 , r ) ⊗ .. {Q}^{tx 1 , {d}_{tx 1}} ( tx 1 , r ) \qquad ( 2 )$$

$${V}^{tx 2} ( tx 2 , r ) = {Q}^{tx 2 , 1} ( tx 2 , r ) ⊗ {Q}^{tx 2 , 2} ( tx 2 , r ) ⊗ .. {Q}^{tx 2 , {d}_{tx 2}} ( tx 2 , r )$$

$${V}^{rx} ( rx , r ) = {Q}^{rx , 1} ( rx , r ) ⊗ {Q}^{rx , 2} ( rx , r ) ⊗ .. {Q}^{rx , {d}_{rx}} ( rx , r )$$

$${V}^{sc} ( sc , r ) = {Q}^{sc , 1} ( sc , r ) ⊗ {Q}^{sc , 2} ( sc , r ) ⊗ .. {Q}^{sc , {d}_{sc}} ( sc , r )$$

$${V}^{tti} ( tti , r ) = {Q}^{tti , 1} ( tti , r ) ⊗ {Q}^{tti , 2} ( tti , r ) ⊗ .. {Q}^{tti , {d}_{tti}} ( tti , r )$$

where ⊗ represents Kronecker product.

The tensor stability to noise depends largely on the tensor dimensionality {dₜₓ₁, dₜₓ₂, dᵣₓ, d_{sc}, dₜₜᵢ}.

### Feasibility of Dimension Splitting of a Channel Tensor

Consider all the tensor sizes of Q^{. . . , . . .} ( . . . , . . . ) to be equal to some size n, the number of dimensionalities is equal to scalar d and a noise tensor E to be elementwise Gaussian with mean 0 and standard deviation 1.

If the total number M=n^{d} of elements of a tensor H is fixed, the theoretical bound for Frobenius norm of error is not more

$${‖ {P}_{R} ( H + E ) - H ‖}^{2} \leq 4 d \cdot ln ( d ) \cdot R \cdot {M}^{\frac{1}{d}} , \qquad ( 3 )$$

For the fixed large amounts of M minimum value of equation above is at d→∞.

P_{R} is the decomposition method, (3) has weak dependence on decomposition method P_{R}.

### Sub-Dimensional Splitting (Dimensions Splitting) of a Channel Tensor

The size of every Q^{. . . ,i}( . . . , . . . ) may be donated as q_{ï} for any r, then for all dimensions:

$${d}_{tx 1} = {\prod }_{k = 1}^{{d}_{tx 1}} {q}_{k}^{tx 1}$$

For example, if Nₜₓ₁=8, it may be represented as a Kronecker product of 2×2×2, and dₜₓ₁=3 and

$${q}_{k}^{tx 1} = 2 ,$$

where k=1 . . . dₜₓ₁.

For N_{sc}=48 is represented as a Kronecker product of 2×2×2×2×3, where d_{sc}=5,

$${q}_{k}^{sc} = 2$$

for k=1.4 and

$${q}_{k}^{sc} = 3$$

for k=5.

It is denoted as i=1,2 . . . index in every V^{. . .} ( . . . ,r) and iₖ=1 . . . q_{\ddot{k}} index in every Q^{. . . ,k}( . . . , . . . ).

In that case index i in every dimension can be presented as

$$i = {i}_{1} + {q}_{\ddot{1}} {i}_{2} + {q}_{\ddot{1}} {q}_{\ddot{2}} {i}_{2} + … + ( {\prod }_{k = 1}^{{d}_{\ddot{}} - 1} {q}_{\ddot{k}} ) {i}_{{d}_{\ddot{}}}$$

Finally, (2) can be represented in form

$${Q}^{.. , k} ( .. , r ) = exp ( j {φ}_{\ddot{r}} ( {\prod }_{l = 1}^{k - 1} {q}_{\ddot{l}} ) {i}_{k} ) \qquad ( 4 )$$

where k=1 . . . d^{. . .}

Finally, the quantized canonical decomposition, or a common canonical decomposition carried out for a tensor with virtual prime-sized dimensions is considered to be a most promising tensor tool for channel denoising followed by extrapolation, which will be described in the next sections. In a possible implementation, the ALS algorithm (alternating least squares) can be used to obtain values φ_{\ddot{r}}, αᵣ, which will be described later in detail.

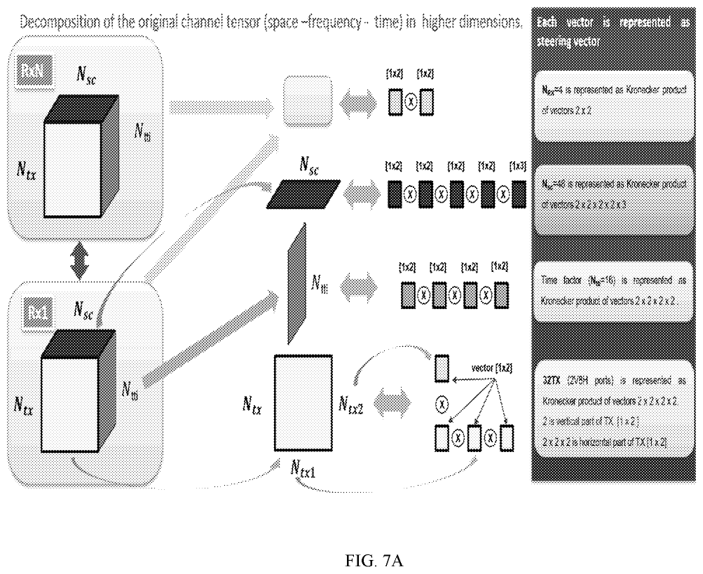

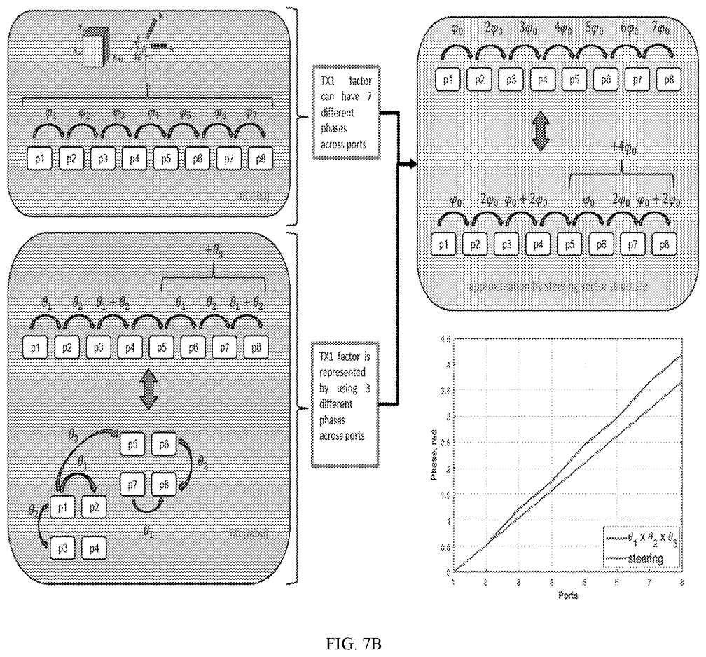

FIG. 7A and FIG. 7B show dimensions splitting of a channel tensor according to one or more example embodiments of the present disclosure.

As shown in FIG. 7A, the original channel is H∈[Nₜₓ=32×Nᵣₓ=4×N_{sc}=48× Nₜₜᵢ=16], if we split the channel on two parts (vertical polarization and horizontal polarization), the following will be obtained:

$$H 1 ∈ [ {N}_{tx} = 16 \times {N}_{rx} = 4 \times {N}_{sc} = 48 \times {N}_{tti} = 16 ]$$

$$H 2 ∈ [ {N}_{tx} = 16 \times {N}_{rx} = 4 \times {N}_{sc} = 48 \times {N}_{tti} = 16 ]$$

After the sub-dimensional splitting for each dimension, we may obtain the following:

$${N}_{tx} = 16 ↔ 2 \times 2 \times 2 \times 2$$

$${N}_{rx} = 4 ↔ 2 \times 2$$

$${N}_{sc} = 48 ↔ 2 \times 2 \times 2 \times 2 \times 3$$

$${N}_{tti} = 16 ↔ 2 \times 2 \times 2 \times 2$$

Therefore, for each tensor, it is split into the smallest sizes. For example, the size of the tensor V^{tx} changes from 1 to 4 sub-dimensions, the size of the tensor V^{sc} changes from 1 to 5 sub-dimensions, and the size of the tensor V^{tti} changes from 1 to 4 sub-dimensions. The size reduction obtained from the above sub-dimensional splitting may be beneficial for saving feedback overhead.

For each of the tensors, the sub-dimensional representation for the tensor can be represented as a Kronecker product of sub-split elements, and the tensor can be represented with at least one sub-dimensional parameter size, the at least one sub-dimensional parameter size of this tensor may include a first sub-dimensional parameter size and a second sub-dimensional parameter size, where the first sub-dimensional parameter size may include at least one factor indicating a size of a sub-dimension, and the second sub-dimensional parameter size represents the number of sub-dimensions for representing the factor vector.

For example, for tensor V^{tx1}(tx1,r), its sub-dimensional representation is V^{tx1}(tx1,r)=Q^{tx1,1}(tx1,r)≈Q^{tx1,2}(tx1,r)⊗ . . . Q^{tx1,d}^{ₜₓ₁}(tx1,r), and its sub-split elements are Q^{tx1,1}(tx1,r), Q^{tx1,2}(tx1,r), . . . . Q^{tx1,d}^{ₜₓ₁}(tx1,r), and the first sub-dimensional parameter size for this tensor includes dₜₓ₁ (the aforementioned first sub-dimensional parameter size) and

$${q}_{k}^{tx 1}$$

(the aforementioned second sub-dimensional parameter size). In this example, dₜₓ₁=3, and

$${q}_{k}^{tx 1} = 2 , k = 1 … {d}_{tx 1} ,$$

which means that the size of sub-dimensions of the tensor is 2, and the number of the sub-dimensions is 3. It should be noted that there may be multiple first sub-dimensional parameter sizes, since for each of the sub-dimensions, their sizes may be different, or some of the sub-dimensions may be different from other sub-dimensions.

For another example, for tensor V^{sc}, its sub-dimensional representation is V^{sc}(sc, r)=Q^{sc,1}(sc,r)⊗Q^{sc,2}(sc,r) ⊗ . . . . Q^{sc,d}^{_{sc}}(sc,r), and its sub-split elements are Q^{sc,1}(sc,r), Q^{sc,2}(sc, r), . . . . Q^{sc,d}^{_{sc}}(sc, r), and the first sub-dimensional parameter size for this tensor includes d_{sc} (the aforementioned first sub-dimensional parameter size) and

$${q}_{k}^{s c}$$

(the aforementioned second sub-dimensional parameter size). In this example, d_{sc}=5, and

$${q}_{k}^{s c} = 2$$

and

$${q}_{k}^{s c} = 3$$

for k=5, which means that the sizes of the sub-dimensions of the tensor are different, so there are two first sub-dimensional parameter sizes 2 and 3, and the number of the sub-dimensions is 5.

In this example, the first preset configuration corresponding to the CSI mentioned above may include, e.g., the number of transmitting antennas, the number of receiving antennas, the number of subcarriers, the number of transmission time intervals (TTIs).

For ease of understanding, reference may be made to FIG. 7B, in which the tensor (factor vector) TX1 is further represented with sub-split elements, so the parameters for representing the tensor is reduced from 7 different phases across parts to 3 different phases across parts.

Therefore, by performing the sub-dimensional splitting, the parameters for representing the factor vector can be reduced, and the feedback overhead may thus be reduced.

S530, the receiver generates a CSI report based on the first estimation of the CSI.

In a possible implementation, the receiver may generate the CSI report based on a second preset configuration and the first estimation of the CSI, where the second preset configuration is indicative of whether a preset structure is applied for a first factor vector of the preset number of factor vectors. Here if there are multiple first factor vectors on which the preset structure(s) is (are) applied, each of the first factor vectors may be of the same preset structure of different preset structures, which is not limited in the embodiments of the present disclosure.

As described in the above example, a certain preset structure may be assumed for the factor vector, in a possible implementation, the preset structure mentioned above may be a parametric structure, which may include at least one of a steering structure, a quadratic structure or a cubic structure, thus flexibility is achieved by introducing various kinds of parametric structures.

For example, still take the above example for description, as illustrated in formula 1), the five tensors are assumed to be of a steering structure, which means that the phase of each element of the tensor follows a certain rule.

In order to let the receiver know the above assumption, the second preset configuration may be indicated by a wireless communication system. In an implementation, the receiver may receive first information indicative of the second preset configuration and second information indicative of the preset number from a wireless communication system. Here the first information may be the second preset configuration, or may be some information including the second preset configuration, which is not limited by the embodiments of the present disclosure. Similarly, the second information may be the preset number, or may be some information including the preset number, which is not limited by the embodiments of the present disclosure.

Switch on/off dimensions or part of dimensions from channel representation can be made, as well as the parameters of algorithm can be adjusted to correspond to the current propagation channel conditions. Here switch on means that the preset structure is applied for the factor vector, and switch off means that the preset structure is not applied for the factor vector, as described above, such switch on/off may be implemented by the second preset configuration.

In a specific implementation, the second preset configuration is indicative of applying the preset structure for the first factor vector. The receiver may perform factor approximation on the first estimation based on a second preset algorithm to derive a characterization parameter of the first factor vector, and generate the CSI report based on the characterization parameter of the first factor vector. Here when the preset structure is applied, since it is a parametric structure, so factor approximation may be done to estimate parameters that could be used for representing the factor vector, still take the above example for description, as illustrated in formula 1), the five tensors are assumed to be of a steering structure, so by performing factor approximation, the receiver may obtain the phases of the tensors V^{sc}, V^{tx1}, V^{tx2} and V^{rx}, and obtain the phase and amplitude of the tensor V^{tti}, all these tensors are the abovementioned first factor vectors since they are all assumed to be in the steering structure, so then these phases and amplitude are the above characterization parameters of these first factor vectors can be used by the receiver to generate the CIS report, for example, the receiver can simply report these characterization parameters, so that the eNodeB could reconstruct the channel based on these characterization parameters. In the solution, by assuming a preset structure for the first factor vector(s) among the preset number of factor vectors, factor approximation could be enabled for the first factor vector(s), thereby making it possible to represent the first factor vector(s) with fewer parameters, thereby reducing feedback overhead.

In another specific implementation, the second preset configuration is indicative of not applying the preset structure for the first factor vector. The receiver may generate the CSI report based on the first estimation. For example, if the first estimation includes also five factor vectors, but none of them is indicated to be of the preset structure, then the receiver may simply report these five factor vectors to the wireless communication system.

It should be noted that the factor vector subject to sub-dimensional splitting and the factor vector which is indicated to be of the preset structure may not be the same factor vector. Besides, if all of the factor vectors included in the first estimation are indicated to be of the preset structure(s), then the receiver may perform factor approximation to obtain the characterization parameters for all of these factor vectors and report the characterization parameters to the wireless communication system. If some of the factor vectors included in the first estimation are indicated to be of the preset structure(s), while some are not, then the receiver may report the characterization parameters of the factor vectors with the preset structure and report the other factor vectors directly.

In an implementation, the receiver may further perform an extrapolation operation on the first estimation to obtain an extrapolated first estimation for a next time unit, and generate the CSI report based on the extrapolated first estimation of the CSI. Since there may be a problem of channel aging, so the estimation of the CSI measured at this time may be different from the future channel (which may be, e.g., used by the wireless communication system for later downlink scheduling), the receiver may choose to generate the CIS report based on the first estimation or may also choose to extrapolate the future first estimation and generate the CSI report based on the extrapolated first estimation. By introducing extrapolation in the process of channel estimation, the extrapolated first estimation may have better robustness in terms of the problem of “channel aging”. Still take the above example for description, as illustrated in formula 1), if we simply choose one dimension, the time dimension to perform extrapolation, then it is possible to accumulate the characterization parameters obtained from several times of factor approximation, and derive a change rule of the amplitude and the phase for the elements of the tensor V^{tti}, then extropolate the future amplitude and the future phase for the elements of the tensor V^{tti} based on such change rule, then take the future amplitude and the future phase as the extrapolated values for the tensor V^{tti}, and report the extrapolated values to the wireless communication system.

As described above, the first preset algorithm may be used for determining the first estimation by using the sub-dimensional representation for each of the at least one factor vector as input, in a possible implementation, we can use random values as initial values of the factor vectors; in another possible implementation, before obtaining the first estimation of the CSI by using the sub-dimensional representation for each of the at least one factor vector as input of the first preset algorithm, the receiver may obtain an initial sub-dimensional representation of each of the at least one factor vector based on the CSI. Then the receiver may obtain the first estimation of the CSI by using the initial sub-dimensional representation as the input of the first preset algorithm.

In an example, the receiver may obtain the initial sub-dimensional representation for each of the at least one factor vector and a rank for the canonical decomposition of the CSI based on a DFT operation of the CSI, and then obtain the first estimation of the CSI by using the initial sub-dimensional representation and the rank for the canonical decomposition as the input of the first preset algorithm.

In one embodiment, the receiver may determine an extended channel matrix based on the CSI and a preset oversampling parameter, perform a Discrete Fourier Transform (DFT) operation on the extended channel matrix to obtain a power spectrum of the CSI, determine the initial sub-dimensional representation for each of the at least one factor vector and the rank for the canonical decomposition of the CSI based on the power spectrum of the CSI, and obtain the first estimation of the CSI by using the initial sub-dimensional representation and the rank for the canonical decomposition as the input of the first preset algorithm.

In another example, the receiver may use an extrapolated first estimation as the initial sub-dimensional representation for each of the at least one factor vector, where the extrapolated first estimation is obtained by performing an extrapolation operation on a first estimation determined in a previous time unit. Then the receiver obtains the first estimation of the CSI by using the initial sub-dimensional representation as the input of the first preset algorithm.

In an implementation, the CSI includes first channel information about a time domain, second channel information about a frequency domain and third channel information about a spatial domain; the preset number of factor vectors includes a time factor vector for characterizing the first channel information, a subcarrier factor vector for characterizing the second channel information, and a transmitting factor vector and a receiving factor vector for characterizing the third channel information; at least one of the time factor vector, the subcarrier factor vector, the transmitting factor vector, and the receiving factor vector is represented with regularly changed phases. As illustrated in the above formula 1), the time factor vector may be V^{tti}, and the subcarrier factor vector may be V^{sc} and the receiving factor vector may be V^{rx}.

The transmitting factor vector may include a first transmitting factor vector and a second transmitting factor vector, the first transmitting factor vector is used for characterizing channel information of at least one vertical polarized antenna port, and the second transmitting factor vector is used for characterizing channel information of at least one horizontal polarized antenna port. By splitting the transmitting factor vector further into two sub-dimensions, the polarization of the transmitting antenna is taken into account, the applicability of the solution is thus improved. As illustrated in the above formula 1), the first transmitting factor vector and the second transmitting factor vector may be V^{tx1} and V^{tx2} respectively. Additional splitting of TX antenna by double dimension is obtained for realization of two-dimensional antenna arrays.

After generating the CSI report based on the first estimation of the CSI, the receiver may further transmit the CSI report to the wireless communication system.

It should be noted that the receiver transmitting the CSI report to the wireless communication system may be transmitting the CSI report to the transmitter mentioned above or any network element in the wireless communication system, which is not limited by the embodiments of the present disclosure. Similarly, the receiver may receive a signal for measuring the CSI from the transmitter, or may receive the signal from other network element in the wireless communication system, which is also limited herein.

The more specific implementations will be described in the following with reference to the above example where the channel state information is represented with five tensors.

### DFT as an Initial Approximation

One of the possible ways to significantly reduce the number of iterations in the ALS algorithm while maintaining an acceptable accuracy is to construct an initial approximation using Discrete Fourier Transform (DFT). Considering the assumptions described above, it was assumed that the factor vectors associated with subcarrier frequencies and transmitting antennas follow the steering structure closely, therefore the following procedure for constructing the initial approximation was proposed.

DFT as initial approximation of the channel for first ALS iterations is made to reduce complexity of algorithm and decrease number of required iterations of ALS.
1) Assume that for all possible values of rx, tx2 and for some initial values tti=1, . . . . N_{tti-cut} of the time-domain index a corresponding two-dimensional channel matrix of size Nₜₓ₁×N_{sc} is selected and denoted as H_{N}_{_{rz}}_{.N}_{ₜₓ₂}_{,N}_{ₜₜᵢ}
2) Assume an oversampling parameter L (corresponding to the above preset oversampling parameter) is selected (for example, L=30), and matrices \tilde{H}_{N}_{_{rz}}_{.N}_{ₜₓ₂}_{,N}_{ₜₜᵢ} (corresponding to the extended channel matrix mentioned above) are introduced with size L·Nₜₓ₁×L·N_{sc} the top-left submatrix of \tilde{H}_{N}_{_{rz}}_{.N}_{ₜₓ₂}_{,N}_{ₜₜᵢ} is equal to H_{N}_{_{rz}}_{.N}_{ₜₓ₂}_{,N}_{ₜₜᵢ}, and all other values of \tilde{H}_{N}_{_{rz}}_{.N}_{ₜₓ₂}_{,N}_{ₜₜᵢ} are equal to zero
3) Assume 2D-FFT is carried out with each extended matrix, and F_{L·tx1}\tilde{H}_{N}_{_{rz}}_{.N}_{ₜₓ₂}_{,N}_{ₜₜᵢ}·F_{L·sc} is computed, where Fₛ is a Fourier matrix with a size s (the step corresponds to the above DFT operation)
4) Assume the results are averaged by taking absolute value of each sample element: let G_{i,j} (corresponding to the above power spectrum of the CSI) of size L·Nₜₓ₁×L·N_{sc}

$${G}_{i , j} = \sqrt{\frac{{\vert {Σ}_{rx , tx 2 , tti} {\tilde{H}}_{{N}_{rz} . {N}_{tx 2} , {N}_{tti}} \vert}^{2}}{{N}_{r x} \cdot {N}_{tx 2} \cdot {N}_{tti - cut}}}$$

The initial approximation is built by selecting canonical rank R as the number of peaks, and converting the corresponding peak indeces i, j to Fourier phases

$${φ}_{r}^{tx 1} = \frac{i}{L \cdot {N}_{t x 1}} , {φ}_{r}^{s c} = \frac{j}{L \cdot {N}_{sc}}$$

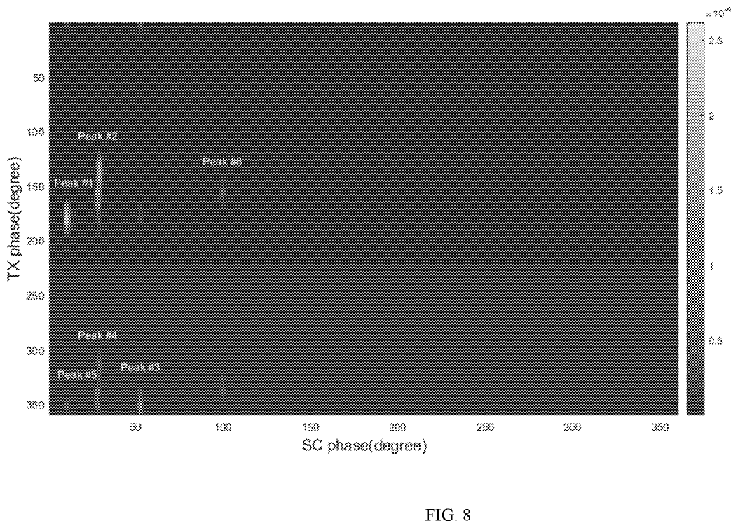

and selecting the canonical factors V^{tx1}(tx1,r) and V^{sc}(sc,r) as steering vectors with the selected phases and each element module equal to 1. FIG. 8 is an illustration of selection of peak for case R=6 according to one or more example embodiments of the present disclosure.

DFT (Discrete Fourier Transform) as initial approximation of the channel for first ALS iterations is made to reduce complexity of algorithm and decrease number of required iterations of ALS.

The remaining factors of the 5D tensor are determined as follows. The factors is looked for in a quantized form.

$${‖ H ( tx 1 , tx 2 , rx , sc , tti ) - {\sum }_{r = 1}^{R} {V}^{tx 1} ( tx 1 , r ) \cdot {Q}^{tx 2 , 1} ( tx 2 , r ) \cdot {Q}^{tx 2 , 2} ( tx 2 , r ) \cdot \\ {Q}^{tx 2 , {d}_{t x 2}} ( tx 2 , r ) \cdot {Q}^{r x , 1} ( rx , r ) \cdot {Q}^{r x , 2} ( rx , r ) \cdot {Q}^{r x , {d}_{r x}} ( rx , r ) \cdot {V}^{s c} ( sc , r ) \cdot \\ {Q}^{tti , 1} ( tti , r ) \cdot {Q}^{tti , 2} ( t ti , r ) \cdot {Q}^{tti , {d}_{t t i}} ( tti , r ) ‖}_{F}^{2} \to \begin{matrix}min \\ {Q}^{… , k} ( … , … ) .\end{matrix}$$

Thus, the initialization for the remaining factors Q^{tx2,k}(tx2,r), Q^{sc,k}(sc,r) and Q^{tti,k}(tti, r) is calculated. It is easy to see that the steering vectors are also easily represented as quantized tensors. Thus, a quantized initial approximation of the tensor is obtained. For each dimension, the obtained factor refers to the above initial sub-dimensional representation for each of the at least one factor vector subject to sub-dimensional splitting.

It is worth noting that the described procedure allows one to quickly get acceptable quality. However, by using a more powerful optimization procedure, the quality of the initialization can be improved. So, the ALS procedure is applied directly to the original tensor with the dimension

$${N}_{tx 1} \times {N}_{tx 2} \times {N}_{r x} \times {N}_{s c} \times {N}_{tti} {‖ H ( tx 1 , tx 2 , rx , sc , tti ) - {\sum }_{r = 1}^{R} {V}^{tx 1} ( tx 1 , r ) \cdot {V}^{tx 2} ( tx 2 , r ) \cdot {V}^{r x} ( rx , r ) \cdot {V}^{s c} ( sc , r ) \cdot {V}^{tti} ( tti , r ) ‖}_{F}^{2} \to \begin{matrix}min \\ {V}^{…} ( … , … ) .\end{matrix}$$

And then each of the factors is quantized using an Q^{. . . ,k} ( . . . , . . . )., e.g.

Then an additional optimization procedure is performed for a tensor with split dimensions and a better initialization is obtained. For comparison, Table 1 below shows the error in the Frobenius norm of the initial initialization, as well as the final quality of extrapolation and approximation on simulation results. It can be seen that ALS initialization gives somewhat better quality, but in practice it takes an unacceptably long time.

TABLE 1

| | | Extrap. err., | Approx. err., |
|---|---|---|---|
| Initialization | Init. err., ∥ • ∥_{F} | SpecEff | SpecEff |
| FFT-based | 0.365 | 96.14 | 96.87 |
| ALS-based | 0.271 | 96.94 | 97.38 |

### Alternating Least Squares Algorithm for Canonical Tensor Decomposition

To construct its canonical decomposition, each tensor dimension and the corresponding factor are considered separately. All factors are fixed except one in V^{tx1}(tx1,r),V^{tx2}(tx2,r),V^{rx}(rx,r),V^{sc}(sc,r),V^{tti}(tti,r).

Multidimensional ALS algorithm is shown below.

Data: Input tensor H(tx1,tx2,rx,sc,tti), rank R, starting point factors. maximum iteration number Nᵢₜₑᵣ

$$iter = 0 \\ ε = {‖ H ( tx 1 , tx 2 , rx , sc , tti ) - {\sum }_{r = 1}^{R} {\prod }_{k} {Q}^{tx 1 , k} ( tx 1 , r ) \cdot {\prod }_{k} {Q}^{tx 2 , k} ( tx 2 , r ) \cdot {\prod }_{k} {Q}^{r x , k} ( rx , r ) \cdot {\prod }_{k} {Q}^{sc , k} ( sc , r ) \cdot {\prod }_{k} {Q}^{tti , k} ( t ti , r ) ‖}_{F}^{2}$$

repeat

### Solve the Linear Squares Problem

$$‖ H ( tx 1 , tx 2 , rx , sc , tti ) - {\sum }_{r = 1}^{R} {\prod }_{k} {Q}^{tx 1 , k} ( t x 1 , r ) \cdot {\prod }_{k} {Q}^{tx 2 , k} ( t x 2 , r ) \cdot {\prod }_{k} {Q}^{r x , k} ( r x , r ) \cdot {\prod }_{k} {Q}^{sc , k} ( s c , r ) \cdot {{\prod }_{k} {Q}^{tti , k} ( t t i , r ) ‖}_{F}^{2} \to min$$

with the QR decomposition with factors V^{tx1}(tx1, r), V^{tx2}(tx2,r), V^{rs}(rx,r),
V^{sc}(sc,r), V^{tti}(tti,r) considering one of factors as variable and the rest of factors as variable.
recalculate

$$ε = {‖ H ( tx 1 , tx 2 , rx , sc , tti ) - {\sum }_{r = 1}^{R} {\prod }_{k} {Q}^{tx 1 , k} ( t x 1 , r ) \cdot {\prod }_{k} {Q}^{tx 2 , k} ( tx 2 , r ) \cdot \\ {\prod }_{k} {Q}^{rx , k} ( rx , r ) \cdot {\prod }_{k} {Q}^{sc , k} ( s c , r ) \cdot {\prod }_{k} {Q}^{tti , k} ( t t i , r ) ‖}_{F}^{2}$$

until iter>Nᵢₜₑᵣ or ε<h

In this formula and further in the text Πₖ—is the notation of the Kronecker product. Threshold h can be set for example, h=10⁻¹³

By applying the ALS algorithm, the rough factors obtained could be regarded as the above mentioned first estimation of the CSI. Then, it is also possible to perform factor approximation, since in this example, all of the five tensors are of the steering structure.

### Factors Approximation

After calculation of rough factors V^{tx1}(tx1,r), V^{tx2}(tx2,r), V^{rx}(rx,r), V^{sc}(sc,r), V^{tti}(tti, r) as the output of ALS, smoothing of factors by φ_{\ddot{r}} and αᵣ is made. Least squares method can be used for this purpose.

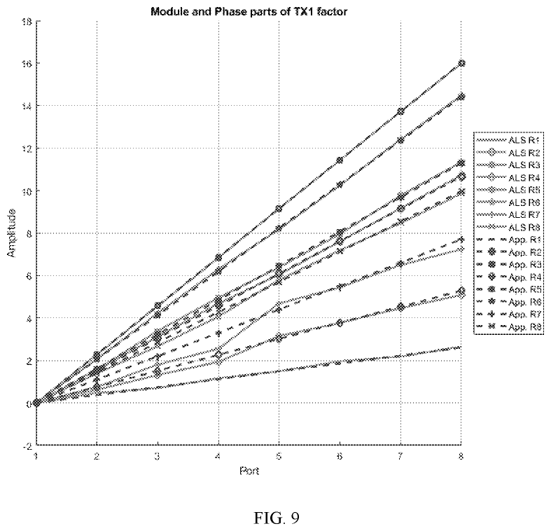

FIG. 9 is an illustration of approximation of TX1 factors for rank R=8 according to one or more example embodiments of the present disclosure. In FIG. 9, green curves represent ALS output, and red curves are filled by linear approximation (interpolated).

FIG. 10 shows output of ALS-rough factors, TTI dimension, 16 samples in time/TTI, ranks 8 for UE1. As shown in FIG. 10, real values of factors according to simulations, provided in accordance with “Quasi Deterministic Radio Channel Generator” (Quadriga, User Manual and Documentation, Document Revision: v2.6.1 Jul. 12, 2021) are presented. N_{tti-cut} is selected during simulations below as 16 when each time sample is taken of 5 ms time interval.

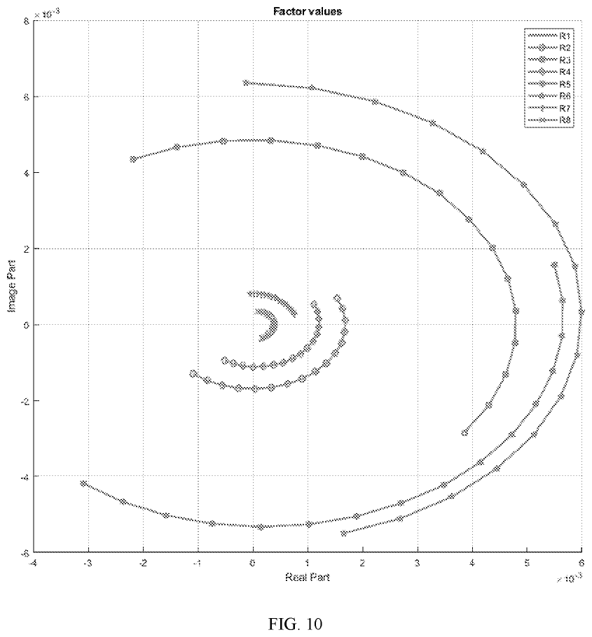

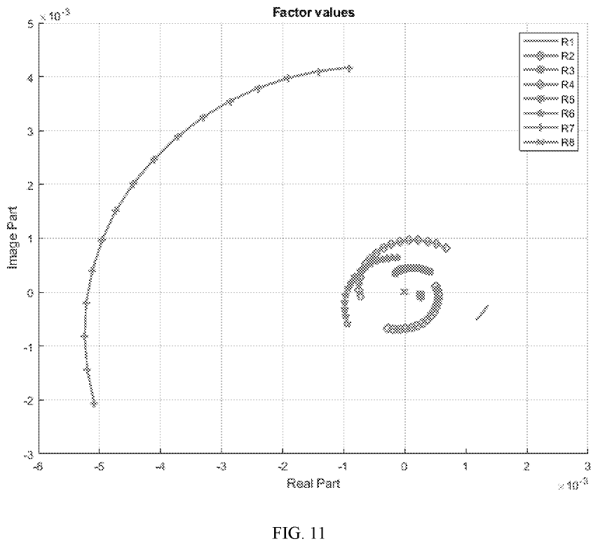

FIG. 11 shows output of ALS—rough factors, TTI dimension, 16 samples in time/TTI, ranks 8 for UE2. As shown in FIG. 11, real values of factors according to simulations, provided in accordance with “Quasi Deterministic Radio Channel Generator” (Quadriga, User Manual and Documentation, Document Revision: v2.6.1 Jul. 12, 2021) are presented. N_{tti-cut} is selected during simulations below as 16 when each time sample is taken of 5 ms time interval.

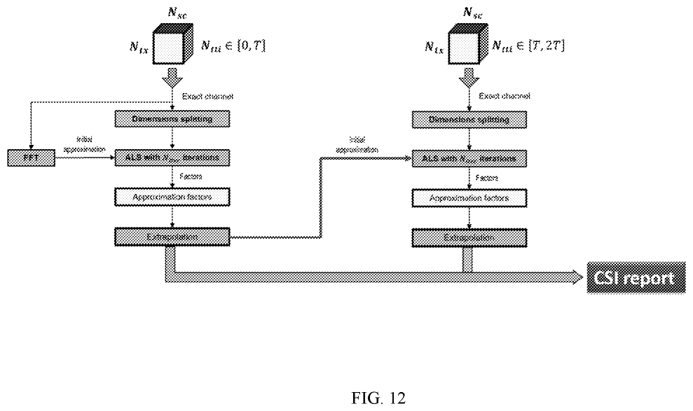

FIG. 12 is a flowchart of extrapolation of factors according to one or more example embodiments of the present disclosure. As shown in FIG. 12, channel extrapolation is made to obtain forecasting samples of the channel in the future.

Generally, each element of the factor can be represented as a product of its absolute value and its complex part:

$$V = \{ {α}_{r}^{i} {e}^{j {φ}_{r}^{i} i} \} .$$

Here i is an index of factor in every dimension.

Supposing that

$${α}_{r}^{i} > 0$$

and taking into account an assumption that the phase changes almost linearly, the dependence of the phase on the index can be approximated by a straight line:

$${φ}_{r}^{i} = p 0 + p 1 \cdot i .$$

But other functions during approximation (extrapolations) can be used.

It is also supposed that the dependence of the logarithm of the amplitude on the index can be approximated by a linear function:

$$ln ( {α}_{r}^{i} ) = g 0 + g 1 \cdot i$$

But also other functions during approximation (extrapolations) can be used.

Coefficients p, g are determined as the least squares solutions that minimize the discrepancies on the stage of interpolation. For example, accumulate the amplitudes and phases for several times to derive the above coefficients based on the least squares solution.

Besides, the extrapolation of the corresponding factor of the tensor of the subsequent time interval can be easily obtained by increasing index i.

The best results were obtained when quadratic extrapolation of amplitude during simulations.

In(αᵣ)=(g0+g1·i)·(g2+g3·i).

Some other functions can be used for approximation purpose.

Values of p0,p1, as well as g0,g1,g2,g3 for every rank r are estimated by:

$$p0 , p 1 = {arg min}_{p 0 , p 1} ( {\sum }_{i} {( {φ}_{r}^{i} - ( p 0 + p 1 \cdot i ) )}^{2} )$$

$$g 0 , g 1 , g 2 , g 3 = {arg min}_{g 0 , g 1 , g 2 , g 3} ( {\sum }_{i} {( ln ( {α}_{r}^{i} ) - ( g 0 + g 1 \cdot i ) \cdot ( g 2 + g 3 \cdot i ) )}^{2} )$$

The present disclosure consists of a mechanism for channel compression to be applied in channel state information feedback. The channel tensor can be considered as a source of random numbers in different dimensions: space (eNodeB and UE), time and frequency. To achieve higher accuracy of a channel approximation and its low parametric representation the design of joint basis across whole domains of a channel is required. The canonical decomposition approach is used to construct such basis. It contains some desired properties for MIMO channel representation as following: 1) a sum of 6-8 rank-one tensors contain almost full energy of a MIMO channel. There are 6-8 dominant clusters in channel that are represented by such sum; 2) canonical decomposition required less parameters for representation in comparison other decomposition approaches such as Tucker (the core size depends on dimension d as Rd, where d-number of channel tensors dimension and R is rank of tensor. It grows exponentially with the virtual dimension count) or Tensor Train; 3) approximation bound of canonical decomposition is less than other decomposition and decays linearly with R; 4) canonical decomposition provides non-orthogonal representation of a MIMO channel. It is well known that MIMO sparse channel has compact representation in non-orthogonal basis.

The introduction of virtual dimensions or splitting dimensions of original channel tensor (factor vector before sub-dimensional splitting) on sub-dimensions. The proposed way to decrease the number of required parameters, which represent MIMO channel, is to get virtual dimensions that contain smallest possible elements (2 elements in each virtual demission). It provides significant parameters reduction that it is required for channel representation with high accuracy. Using virtual dimensions provides constrain on type of non-orthogonal basis from mathematical point of view. It means what MIMO channel is represented in piecewise linear non-orthogonal basis.

Approximation of the channel in each virtual dimension is carried out by vectors having a so called “steering” structure. It allows UE to decrease overhead and decrease size of tensor without loss of performance.

To make the solution resistance to the problem of “channel aging” due to round trip delay or aperiodic nature of CSI report the prediction approach is applied. So, extrapolation of factors, having “steering” structure over the time, is made to obtain prediction of the channel in the future.

Outside of the main idea of the present disclosure, the present disclosure may be extended by using approximation of the channel in dimensions by vectors having not only “steering” structure—for example, quadratic, cubic approximation, and so on.

Different of channel approximation can increase the decomposition characteristics in especially rapid propagation channels like hard multipath profile, high subscriber speed, etc.

Approximation can be made by other methods, not only ALS—for example, Levenberg-Marquardt algorithm, etc., which can reduce complexity or obtain regularity of factors in time.

Using of one common amplitude coefficient for all dimensions, associated with only one of the dimensions (time for example) is made to reduce the total size of representation and reduce overhead.

This solution can be implemented in any massive MIMO FDD communication system by adding to the subscriber station the corresponding equipment that compresses the channel in accordance with the algorithm described in this disclosure and transmits the coefficients of compressed channel to the base station via one of the special service channels.

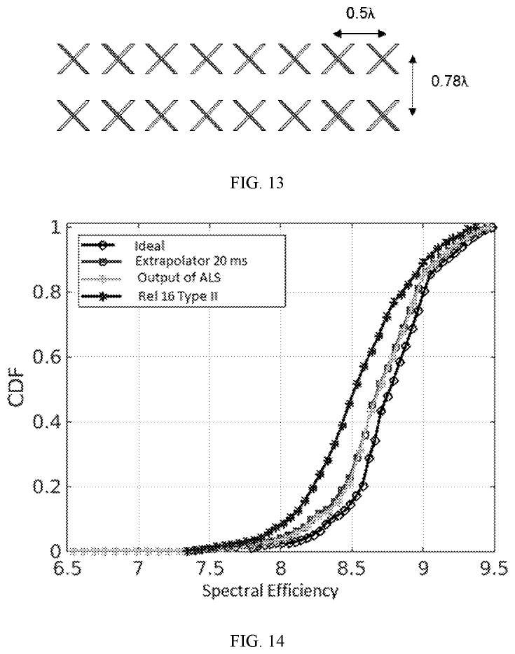

FIG. 13 is an example with 32 transmitting antennas according to one or more example embodiments of the present disclosure. As shown in FIG. 13, the antenna array has a structure of 8 columns, 2 rows and cross-polarized pair elements with ±45°. The central frequency is set to 2.14 GHz and elements are separated 0.52 in horizontal and 0.782 in vertical. For the experiment, a 10 MHz FDD system is considered with 7×3 eNodeBs (21 cells) for the network deployment. Other relevant parameters are presented in Table 2.

TABLE 2
Main simulation parameters

| Scenario | Parameter | |
|---|---|---|
| Multiplexing | FDD | |
| Carrier Frequency | 2.1 | GHz |
| Bandwidth | 10 | MHz |
| Sub-band | 48 sub-band | |
| Granularity | (2RB/sub-band) | |
| Num. Antennas | 32Tx (2 rows, 8 columns, | |
| eNodeB | 2 polarization) | |
| Num. Antennas UE | 4 | |
| Number of Cells | 7 × 3 | cells |
| Inter-site Distance | 500 | m |
| Number of UEs | 40 | |
| UE height | 1.5 | m |
| BS height | 29 | m |
| Channel Model | QuaDriga | |
| Scenario | UMa/NLOS, Berlin Uma | |
| | NLOS | |
| AS Horizontal | 15 | deg |
| AS Vertical | 6 | deg |
| Mobility of UEs | 2-20 | km/h |

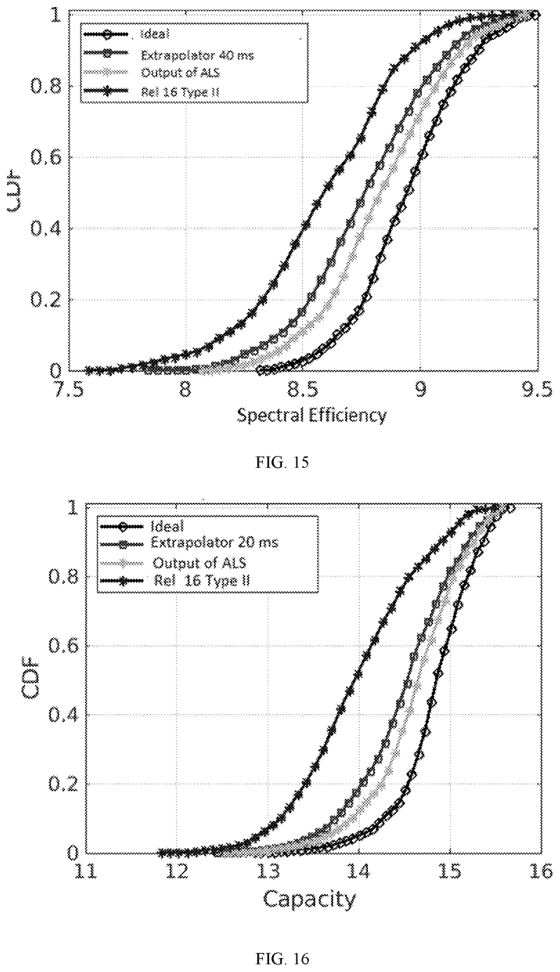

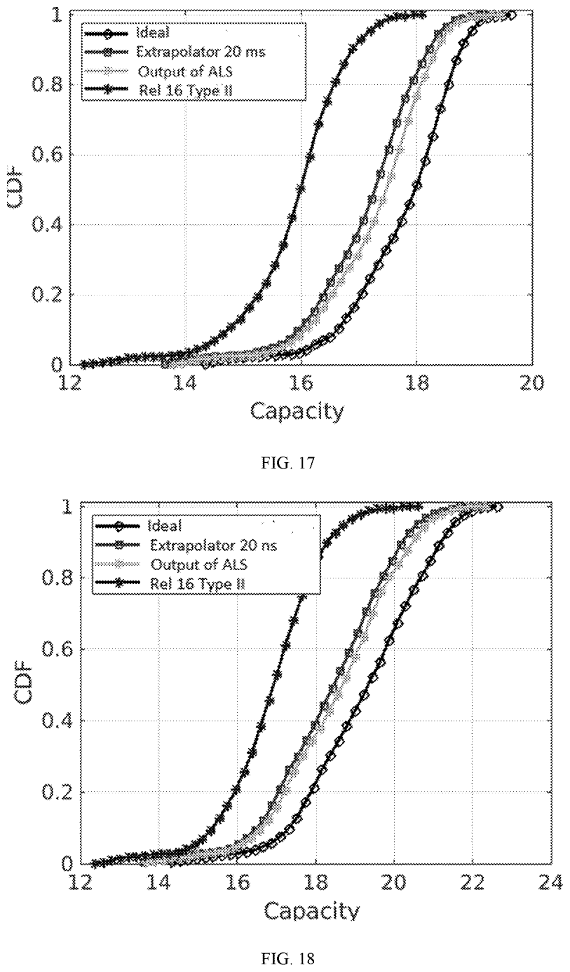

The results of implementation of proposed algorithm in telecommunication system are shown in FIG. 14 to FIG. 18, where FIG. 14 is a result of simulation for single-layer transmission according to one or more example embodiments of the present disclosure; FIG. 15 is another result of simulation for single-layer transmission according to one or more example embodiments of the present disclosure; FIG. 16 is a result of simulation for two-layer transmission according to one or more example embodiments of the present disclosure; FIG. 17 is a result of simulation for three-layer transmission according to one or more example embodiments of the present disclosure; and FIG. 18 is a result of simulation for four-layer transmission according to one or more example embodiments of the present disclosure.

FIG. 14 illustrates a result of simulation for single-layer transmission of Quadriga 3GPP Uma NLOS channel, 2.14 GHZ, 3 km/h, extrapolation on 20 ms. FIG. 15 illustrates a result of simulation for single-layer transmission of Quadriga Berlin Uma NLOS channel, 2.14 GHz, 10 km/h, extrapolation on 40 ms. FIG. 16 illustrates a result of simulation for two-layer transmission of Quadriga Berlin Uma NLOS channel, 2.14 GHz, 10 km/h, extrapolation on 20 ms. FIG. 17 illustrates a result of simulation for three-layer transmission of Quadriga Berlin Uma NLOS channel, 2.14 GHZ, 10 km/h, extrapolation on 20 ms. FIG. 18 illustrates a result of simulation for four-layer transmission of Quadriga Berlin Uma NLOS channel, 2.14 GHZ, 10 km/h, extrapolation on 20 ms.

In order to estimate the efficiency of the channel approximations, metric called “spectral efficiency” is used. For each subcarrier domain index and for each time domain index value the corresponding channel matrix of size Nₜₓ×Nᵣₓ is considered independently.

Assume for each sc,tti, the row orthogonal bases of the true H and approximate matrices \tilde{H} of propagation channel of the size Nₜₓ×Nᵣₓ are calculated and denoted as U and Ũ respectively.

The singular values of σᵣₓ=σᵣₓ(HU*) and \tilde{σ}ᵣₓ=σᵣₓ(HŨ*) are then computed for =1 . . . . Nᵣₓ.

The spectral efficiency is then defined as

$$F ( H , \tilde{H} ) = {Σ}_{r x . s c . ti} {log}_{2} ( 1 + \frac{{\tilde{σ}}_{r x}}{{σ}^{2}} ) .$$

Ideal spectral efficiency is defined as

$$F ( H , H ) = {Σ}_{r x . s c . ti} {log}_{2} ( 1 + \frac{{σ}_{r x}}{{σ}^{2}} ) ,$$

where σ² represents noise power.

The results of simulations for single-layer transmission are presented in FIG. 14 and FIG. 15. In FIG. 14, extrapolation was carried out on value 20 ms, and in FIG. 15, extrapolation was carried on value 40 ms. Signal to noise ratio is selected to 30 dB. Simulations are carried out for different users located randomly at different distances from BS. Speed of all users is selected to 3 km/h in FIG. 14 and to 10 km/h in FIG. 15. Here on FIG. 14 and FIG. 15, “Extrapolator” and “Output of ALS”—raw data from ALS algorithm output without extrapolation and without filling by steering vectors are considered as some variant of potentially achievable characteristics.

The results of simulations for two-layer, three-layer and four-layer transmission are presented in FIG. 16, 17, 18 correspondingly.

The total characteristics can be presented on the Table 3 and Table 4 below. Here the ratio of the spectral efficiency of the algorithm to the ideal one in % is presented.

TABLE 3
Total characteristics

| Velocity, | Output of | | |
|---|---|---|---|
| km/h | ALS, % | Interpolated, % | Extrapolated, % |
| 2 | 98.26 | 97.53 | 96.71 |
| 3 | 97.29 | 96.88 | 91.69 |
| 5 | 96.35 | 95.63 | 86.66 |
| 10 | 94.87 | 94.26 | 84.09 |
| 20 | 91.65 | 90.81 | 78.42 |

TABLE 4
Total characteristics

| Rank | Output of ALS, % |
|---|---|
| 2 | 93.16 |
| 4 | 98.25 |
| 6 | 99.53 |
| 10 | 99.87 |

With the wireless communication method provided in the present disclosure, a receiver generates the CSI report based on a first estimation of the CSI which is used for representing a canonical decomposition of the CSI and includes a preset number of factor vectors, where at least one factor vector of the preset number of factor vectors is subject to sub-dimensional splitting. By using the first estimation for representing the canonical decomposition of the CSI and making at least one factor vector of the preset number of factor vectors included in the first estimation being subject to sub-dimensional splitting, the parameters required for channel representation with high accuracy can be significantly reduced, thereby realizing CSI reporting with less feedback overhead.

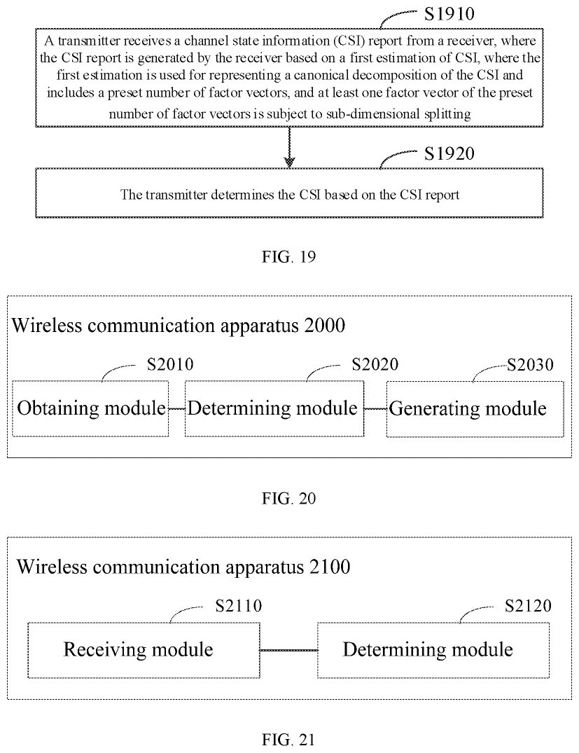

In the above, the wireless communication method of the present disclosure is described from the perspective of the receiver (such as the terminal device) in combination with FIG. 5 to FIG. 18. In the following, a wireless communication method of the present disclosure will be described from the perspective of the transmitter (such as the network device) in combination with FIG. 19.

FIG. 19 is another schematic flowchart of a wireless communication method according to one or more example embodiments of the present disclosure. The method can be implemented by a transmitter. Optionally, the transmitter may be a network device or other device that has similar function (for example, the transmitter could be a chip), which is not limited herein. As shown in FIG. 19, the method may include the following steps.

S1910, a transmitter receives a CSI report from a receiver, where the CSI report is generated by the receiver based on a first estimation of CSI, where the first estimation is for representing a canonical decomposition of the CSI and includes a preset number of factor vectors, and at least one factor vector of the preset number of factor vectors is subject to sub-dimensional splitting.

Here the CSI is actual channel state information between the transmitter and the receiver. The CSI may also be referred to as, e.g., exact CSI that is measured by the receiver. The measurement may be made based on a signal sent from the transmitter to the receiver. Techniques in existing art may be adopted here for obtaining the CSI, which will not be elaborated here for brevity.

Here the sub-dimensional splitting may also be called virtual dimension splitting. The principle is to divide a size of a factor vector into smallest possible sizes, so as to represent the factor vector with sub-split elements in sub-dimensions (virtual dimensions), the size of the factor vector before the sub-dimensional splitting may be greater than the size of each sub-dimensions of the factor vector after the sub-dimensional splitting.

By using the sub-dimensional splitting, the smallest possible sizes may be introduced for representing the factor vector, such splitting may contribute to the reduction of parameters used for representing the factor vector. Normally, the size of the factor vector may be split in a way that the sizes of the sub-dimensions are the smallest possible integers.

It should be noted that the at least one factor vector here could be one of the preset number of factor vectors, or all of the preset number of factor vectors, or could also be some of them, which is not limited by the embodiments of the present disclosure. When multiple factor vectors among the preset number of factor vectors are subject to sub-dimensional splitting, the sub-dimensions involved with such splitting for the respective factor vectors may be the same, or different, which is not limited by the embodiments of the present disclosure.

It should be noted that the number of the factor vectors before the sub-dimensional splitting (the preset number), the number of factor vectors subject to the sub-dimensional splitting (those called “at least one factor vector in the above description”), as well as other terms in the example embodiments are just for illustration purpose, rather than limitation.

S1920, the transmitter determines the CSI based on the CSI report.

In an implementation, the transmitter may transmit first information indicative of second preset configuration and second information indicative of the preset number to the receiver, where the second preset configuration is indicative of whether a preset structure is applied for a first factor vector of the preset number of factor vectors. Here the first information may be the second preset configuration, or may be some information including the second preset configuration, which is not limited by the embodiments of the present disclosure. Similarly, the second information may be the preset number, or may be some information including the preset number, which is not limited by the embodiments of the present disclosure.

In a specific implementation, the second preset configuration is indicative of applying the preset structure for the first factor vector. As described at the receiver side, the receiver may perform factor approximation on the first estimation based on a second preset algorithm to derive a characterization parameter of the first factor vector, and generate the CSI report based on the characterization parameter of the first factor vector. Here when the preset structure is applied, since it is a parametric structure, so factor approximation may be done to estimate parameters that could be used for representing the factor vector, still take the above example for description, as illustrated in formula 1), the five tensors are assumed to be of a steering structure, so by performing factor approximation, the receiver may obtain the phases of the tensors V^{sc}, V^{tx1}, V^{tx2} and V^{rx}, and obtain the phase and amplitude of the tensor V^{tti}, all these tensors are the abovementioned first factor vectors since they are all assumed to be in the steering structure, so then these phases and amplitude which are the above characterization parameters of these first factor vectors can be used by the receiver to generate the CIS report, for example, the receiver can simply report these characterization parameters, so that the eNodeB could reconstruct the channel based on these characterization parameters.

In another specific implementation, the second preset configuration is indicative of not applying the preset structure for the first factor vector. As described at the receiver side, the receiver may generate the CSI report based on the first estimation. For example, if the first estimation includes also five factor vectors, but none of them is indicated to be of the preset structure, then the receiver may simply report these five factor vectors to the wireless communication system.

For the reconstructing of the channel at the transmitter side, e.g., the eNodeB, canonical decomposition may also be used as at the receiver side, the details may be referred to the description at the receiver side, and the technical effect is similar, which are not repeated herein.

The specific implementation of the wireless communication method at the transmitter side may be understood with reference to the example embodiments of the wireless communication at the receiver side, and the technical effect achieved is similar, which are not repeated herein.

Next, examples of products related to the wireless communication methods will be described.

FIG. 20 is a schematic structural diagram of a wireless communication apparatus 2000 according to one or more example embodiments of the present disclosure.

As shown in FIG. 20, the wireless communication apparatus 2000 may include:
an obtaining module 2010, configured to obtain CSI;
a determining module 2020, configured to determine a first estimation of the CSI, where the first estimation is for representing a canonical decomposition of the CSI and includes a preset number of factor vectors, where at least one factor vector of the preset number of factor vectors is subject to sub-dimensional splitting; and
a generating module 2030, configured to generate a CSI report based on the first estimation of the CSI.

In a possible implementation, the determining module 2020 includes:
a determining unit, configured to determine a sub-dimensional representation for each of the at least one factor vector; and
a first obtaining unit, configured to obtain the first estimation of the CSI based on the sub-dimensional representation for each of the at least one factor vector.

In a possible implementation, the determining unit is configured to:
determine at least one sub-dimensional parameter size for each of the at least one factor vector based on a first preset configuration corresponding to the CSI; and
represent for each of the at least one factor vector with the at least one sub-dimensional parameter size for each of the at least one factor vector.

In a possible implementation, for each of the at least one factor vector: the at least one sub-dimensional parameter size includes a first sub-dimensional parameter size and a second sub-dimensional parameter size, where the first sub-dimensional parameter size includes at least one factor indicating a size of a sub-dimension, and the second sub-dimensional parameter size represents a number of sub-dimensions for representing the factor vector; where the sub-dimensional representation for the factor vector is a Kronecker product of sub-split elements, where each of the sub-split elements is represented in an exponential form based on a phase corresponding to the factor vector, the first sub-dimensional parameter size of the factor vector and the second sub-dimensional parameter size of the factor vector.

In a possible implementation, the first preset configuration is indicative of a number of sub-dimensions for the sub-dimensional splitting of each of the at least one factor vector and a size of a respective sub-dimension of the sub-dimensions.

In a possible implementation, the first obtaining unit is configured to: obtain the first estimation of the CSI by using the sub-dimensional representation for each of the at least one factor vector as input of a first preset algorithm.

In a possible implementation, the generating module 2030 is configured to: generate the CSI report based on a second preset configuration and the first estimation of the CSI, where the second preset configuration is indicative of whether a preset structure is applied for a first factor vector of the preset number of factor vectors.

In a possible implementation, the second preset configuration is indicative of applying the preset structure for the first factor vector of the preset number of factor vectors; where the generating module 2030 is configured to:
perform factor approximation on the first estimation based on a second preset algorithm to derive a characterization parameter of the first factor vector; and
generate the CSI report based on the characterization parameter of the first factor vector.

In a possible implementation, the second preset configuration is indicative of not applying the preset structure for the first factor vector of the preset number of factor vectors; where the generating module 2030 is configured to: generate the CSI report based on the first estimation.

In a possible implementation, the preset structure is a parametric structure.

In a possible implementation, the parametric structure includes at least one of a steering structure, a quadratic structure or a cubic structure.

In a possible implementation, the apparatus 2000 further includes: a first receiving module, configured to receive first information indicative of the second preset configuration from a wireless communication system.

In a possible implementation, the generating module 2030 is further configured to:
perform an extrapolation operation on the first estimation to obtain an extrapolated first estimation for a next time unit; and
generate the CSI report based on the extrapolated first estimation of the CSI.

In a possible implementation, the determining module 2020 further includes a second obtaining unit, which is configured to: before the first obtaining unit obtains the first estimation of the CSI by using the sub-dimensional representation for each of the at least one factor vector as input of a first preset algorithm, obtain an initial sub-dimensional representation of each of the at least one factor vector based on the CSI; and the first obtaining unit is configured to: obtain the first estimation of the CSI by using the initial sub-dimensional representation as the input of the first preset algorithm.

In a possible implementation, the second obtaining unit is configured to obtain the initial sub-dimensional representation for each of the at least one factor vector and a rank for the canonical decomposition of the CSI based on a DFT operation of the CSI; and the first obtaining unit is configured to obtain the first estimation of the CSI by using the initial sub-dimensional representation and the rank for the canonical decomposition as the input of the first preset algorithm.

In a possible implementation, the first obtaining unit is configured to:
determine an extended channel matrix based on the CSI and a preset oversampling parameter;
perform a Discrete Fourier Transform DFT operation on the extended channel matrix to obtain a power spectrum of the CSI; and
determine the initial sub-dimensional representation for each of the at least one factor vector and the rank for the canonical decomposition of the CSI based on the power spectrum of the CSI.

In a possible implementation, the second obtaining unit is configured to use an extrapolated first estimation as the initial sub-dimensional representation for each of the at least one factor vector, where the extrapolated first estimation is obtained by performing an extrapolation operation on a first estimation determined in a previous time unit.

In a possible implementation, the CSI includes first channel information about a time domain, second channel information about a frequency domain and third channel information about a spatial domain; the preset number of factor vectors includes a time factor vector for characterizing the first channel information, a subcarrier factor vector for characterizing the second channel information, and a transmitting factor vector and a receiving factor vector for characterizing the third channel information; where at least one of the time factor vector, the subcarrier factor vector, the transmitting factor vector, and the receiving factor vector is represented with regularly changed phases.

In a possible implementation, the apparatus 2000 further includes: a transmitting module, configured to transmit the CSI report to a wireless communication system.

In a possible implementation, the apparatus 2000 further includes: a second receiving module, configured to receive second information indicative of the preset number from a wireless communication system.

The wireless communication apparatus 2000 may be applied to the above receiver as described in the above possible method implementations. It should be understood by a person skilled in the art that, the relevant description of the above modules in these possible implementations of the present disclosure may be understood with reference to the relevant description of the wireless communication method in these possible implementations of the present disclosure. The technical effect achieved by the above wireless communication apparatus 2000 is similar as that achieved by the above possible method implementation, which is not repeated herein.

FIG. 21 is a schematic structural diagram of a wireless communication apparatus 2100 according to one or more example embodiments of the present disclosure.

As shown in FIG. 21, the wireless communication apparatus 2100 may include:
a receiving module 2110, configured to receive a CSI report from a receiver, where the CSI report is generated by the receiver based on a first estimation of CSI, where the first estimation is for representing a canonical decomposition of the CSI and includes a preset number of factor vectors, and at least one factor vector of the preset number of factor vectors is subject to sub-dimensional splitting; and
a determining module 2120, configured to determine the CSI based on the CSI report.

In a possible implementation, the wireless communication apparatus 2100 further includes:
a first transmitting module, configured to transmit first information indicative of second preset configuration to the receiver, where the second preset configuration is indicative of whether a preset structure is applied for a first factor vector of the preset number of factor vectors.

In a possible implementation, the wireless communication apparatus 2100 further includes:
a second transmitting module, configured to transmit second information indicative of the preset number to the receiver.

The wireless communication apparatus 2100 may be applied to the above transmitter as described in the above possible method implementations. It should be understood by a person skilled in the art that, the relevant description of the above modules in these possible implementations of the present disclosure may be understood with reference to the relevant description of the communication method in these possible implementations of the present disclosure. The technical effect achieved by the above wireless communication apparatus 2100 is similar as that achieved by the above possible method implementations, which is not repeated herein.

A possible implementation of the present disclosure provides a terminal device including a processing circuitry for executing any of the above the wireless communication methods at the receiver side, which is not repeated herein.

A possible implementation of the present disclosure provides a network device including a processing circuitry for executing any of the wireless communication methods at the transmitter side, which is not repeated herein.

A possible implementation of the present disclosure provides a wireless communication system including: a terminal device for executing any of the above the wireless communication methods at the receiver side or a wireless communication apparatus for executing any of the above the wireless communication methods at the receiver side; and a network device for executing any of the above the wireless communication methods at the transmitter side or a wireless communication apparatus for executing any of the above the wireless communication methods at the transmitter side.

A possible implementation of the present disclosure provides a chip, including an input/output (I/O) interface and a processor, where the processor is configured to call and run computer execution instructions stored in a memory, to enable a device installing with the chip to execute any of the wireless communication methods at the receiver side or any of the wireless communication methods at the transmitter side.

A possible implementation of the present disclosure provides a computer-readable storage medium storing computer execution instructions which, when executed by a processor, cause the processor to execute any of the wireless communication methods at the receiver side or any of the wireless communication methods at the transmitter side.

A possible implementation of the present disclosure provides a computer program product including computer execution instructions which, when executed by a processor, causes the processor to execute any of the wireless communication methods at the receiver side or any of the wireless communication methods at the transmitter side.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

1. A method for wireless communication, performed by a wireless communication apparatus, comprising:
obtaining channel state information (CSI);
determining a first estimation of the CSI, wherein the first estimation of the CSI represents a canonical decomposition of the CSI and comprises a preset number of factor vectors, wherein at least one factor vector of the preset number of factor vectors is subject to sub-dimensional splitting; and
generating a CSI report based on the first estimation of the CSI.

2. The method according to claim 1, wherein the determining the first estimation of the CSI comprises:
determining a sub-dimensional representation for each of the at least one factor vector; and
obtaining the first estimation of the CSI based on the sub-dimensional representation for each of the at least one factor vector.

3. The method according to claim 2, wherein the determining, by the receiver, the sub-dimensional representation for each of the at least one factor vector comprises:
determining at least one sub-dimensional parameter size for each of the at least one factor vector based on a first preset configuration corresponding to the CSI; and
representing for each of the at least one factor vector with the at least one sub-dimensional parameter size for each of the at least one factor vector.

4. The method according to claim 3, wherein for each of the at least one factor vector:
the at least one sub-dimensional parameter size comprises a first sub-dimensional parameter size and a second sub-dimensional parameter size, wherein the first sub-dimensional parameter size comprises at least one factor indicating a size of a sub-dimension, and the second sub-dimensional parameter size represents a number of sub-dimensions for representing the factor vector;
wherein the sub-dimensional representation for the factor vector is a Kronecker product of sub-split elements, wherein each of the sub-split elements is represented in an exponential form based on a phase corresponding to the factor vector, the first sub-dimensional parameter size of the factor vector and the second sub-dimensional parameter size of the factor vector.

5. The method according to claim 3, wherein the first preset configuration indicates a number of sub-dimensions for the sub-dimensional splitting of each of the at least one factor vector and a size of a respective sub-dimension of the sub-dimensions.

6. The method according to claim 2, wherein the obtaining the first estimation of the CSI based on the sub-dimensional representation for each of the at least one factor vector comprises:
obtaining the first estimation of the CSI by using the sub-dimensional representation for each of the at least one factor vector as input of a first preset algorithm.

7. The method according to claim 6, wherein the generating, by the receiver, the CSI report based on the first estimation of the CSI comprises:
generating the CSI report based on a second preset configuration and the first estimation of the CSI, wherein the second preset configuration indicates whether a preset structure is applied for a first factor vector of the preset number of factor vectors.

8. An apparatus for wireless communication, comprising:
at least one processor coupled to one or more memories storing programming instructions that, when executed by the at least one processor, cause the apparatus to:
obtain channel state information (CSI);
determine a first estimation of the CSI, wherein the first estimation of the CSI represents a canonical decomposition of the CSI and comprises a preset number of factor vectors, wherein at least one factor vector of the preset number of factor vectors is subject to sub-dimensional splitting; and
generate a CSI report based on the first estimation of the CSI.

9. The apparatus according to claim 8, wherein the programming instructions, when executed by the at least one processor, further cause the apparatus to:
determine a sub-dimensional representation for each of the at least one factor vector; and
obtain the first estimation of the CSI based on the sub-dimensional representation for each of the at least one factor vector.

10. The apparatus according to claim 8, wherein the programming instructions, when executed by the at least one processor, further cause the apparatus to:
determine at least one sub-dimensional parameter size for each of the at least one factor vector based on a first preset configuration corresponding to the CSI; and
represent for each of the at least one factor vector with the at least one sub-dimensional parameter size for each of the at least one factor vector.

11. The apparatus according to claim 10, wherein for each of the at least one factor vector:
the at least one sub-dimensional parameter size comprises a first sub-dimensional parameter size and a second sub-dimensional parameter size, wherein the first sub-dimensional parameter size comprises at least one factor indicating a size of a sub-dimension, and the second sub-dimensional parameter size represents a number of sub-dimensions for representing the factor vector;
wherein the sub-dimensional representation for the factor vector is a Kronecker product of sub-split elements, wherein each of the sub-split elements is represented in an exponential form based on a phase corresponding to the factor vector, the first sub-dimensional parameter size of the factor vector and the second sub-dimensional parameter size of the factor vector.

12. The apparatus according to claim 10, wherein the first preset configuration indicates a number of sub-dimensions for the sub-dimensional splitting of each of the at least one factor vector and a size of a respective sub-dimension of the sub-dimensions.

13. The apparatus according to claim 9, wherein the programming instructions, when executed by the at least one processor, further cause the apparatus to:
obtain the first estimation of the CSI by using the sub-dimensional representation for each of the at least one factor vector as input of a first preset algorithm.

14. The apparatus according to claim 13, wherein the programming instructions, when executed by the at least one processor, further cause the apparatus to:
generate the CSI report based on a second preset configuration and the first estimation of the CSI, wherein the second preset configuration indicates whether a preset structure is applied for a first factor vector of the preset number of factor vectors.

15. A non-transitory computer-readable storage medium storing computer instructions that, when executed by a processor of a wireless communication apparatus, cause the wireless communication apparatus to:
obtain channel state information (CSI);
determine a first estimation of the CSI, wherein the first estimation of the CSI represents a canonical decomposition of the CSI and comprises a preset number of factor vectors, wherein at least one factor vector of the preset number of factor vectors is subject to sub-dimensional splitting; and
generate a CSI report based on the first estimation of the CSI.

16. The non-transitory computer-readable storage medium according to claim 15, wherein the computer instructions, when executed by the processor of the wireless communication apparatus, further cause the wireless communication apparatus to:
determine a sub-dimensional representation for each of the at least one factor vector; and
obtain the first estimation of the CSI based on the sub-dimensional representation for each of the at least one factor vector.

17. The non-transitory computer-readable storage medium according to claim 15, wherein the computer instructions, when executed by the processor of the wireless communication apparatus, further cause the wireless communication apparatus to:
determine at least one sub-dimensional parameter size for each of the at least one factor vector based on a first preset configuration corresponding to the CSI; and
represent for each of the at least one factor vector with the at least one sub-dimensional parameter size for each of the at least one factor vector.

18. The non-transitory computer-readable storage medium according to claim 17, wherein for each of the at least one factor vector:
the at least one sub-dimensional parameter size comprises a first sub-dimensional parameter size and a second sub-dimensional parameter size, wherein the first sub-dimensional parameter size comprises at least one factor indicating a size of a sub-dimension, and the second sub-dimensional parameter size represents a number of sub-dimensions for representing the factor vector;
wherein the sub-dimensional representation for the factor vector is a Kronecker product of sub-split elements, wherein each of the sub-split elements is represented in an exponential form based on a phase corresponding to the factor vector, the first sub-dimensional parameter size of the factor vector and the second sub-dimensional parameter size of the factor vector.

19. The non-transitory computer-readable storage medium according to claim 17, wherein the first preset configuration indicates a number of sub-dimensions for the sub-dimensional splitting of each of the at least one factor vector and a size of a respective sub-dimension of the sub-dimensions.

20. The non-transitory computer-readable storage medium according to claim 16, wherein the computer instructions, when executed by the processor of the wireless communication apparatus, further cause the wireless communication apparatus to:
obtain the first estimation of the CSI by using the sub-dimensional representation for each of the at least one factor vector as input of a first preset algorithm.
